(19) United States
(12) Patent Application Publication
(10) Pub. No.: US 2025/0337630 A1
(43) Pub. Date: Oct. 30, 2025

(54) TRANSMIT DEVICE FOR GENERATING AN OOK MODULATED SPREAD DFT-S-OFDM WAKE-UP SIGNAL

(71) Applicant: HUAWEI TECHNOLOGIES CO., LTD., Shenzhen (CN)

(72) Inventor: Renaud-Alexandre Pitaval, Kista (SE)

(73) Assignee: HUAWEI TECHNOLOGIES CO., LTD., Shenzhen (CN)

(21) Appl. No.: 19/263,028

(22) Filed: Jul. 8, 2025

Related U.S. Application Data
(63) Continuation of application No. PCT/EP2023/050282, filed on Jan. 9, 2023.

(51) Int. Cl. H04L 27/26

(52) U.S. Cl. CPC H04L 27/2666; H04L 27/2651

(57) ABSTRACT

An orthogonal frequency-division multiplexing (OFDM) signal is obtained by spreading a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences. Each spreading sequence in the sequence of N_{bit} number of spreading sequences is a linear phase sequence having a constant rotational phase angle Φ. The N_{symb} number of modulation symbols are multiplied with a discrete Fourier transform precoder to obtain N_{symb} number of Fourier coefficients. The OFDM signal including the N_{symb} number of Fourier coefficients mapped onto K number of OFDM subcarriers is transmitted.

### CROSS-REFERENCE TO RELATED APPLICATIONS

This application is a continuation of International Application No. PCT/EP2023/050282, filed on Jan. 9, 2023, the disclosure of which is hereby incorporated by reference in its entirety.

### FIELD

Embodiments of the present disclosure include a transmit device for a communication system as well as corresponding methods and a computer program.

### BACKGROUND

The concept of wake-up signal (WUS) has been introduced in several communication standards of the wireless industry. The goal is to help devices to significantly reduce their functionalities and thus power consumption until reception of such specific WUS.

In previous 3^{rd} Generation Partnership Project (3GPP) releases, Long Term Evolution Machine Type Communication (LTE-M) and narrowband Internet of things (NB-IoT) specified a so-called machine type communication (MTC) wake-up signal (MWUS) and the narrowband WUS (NWUS), respectively. These are specific kinds of orthogonal frequency-division multiplexing (OFDM) signals designed for a normal 3GPP new radio (NR) receiver, i.e., an OFDM-modulated Zadoff-Chu (ZC) sequence which encodes the cell identity (ID). As a result, an OFDM-based WUS, must maintain orthogonality to other signals, which also requires a high level of synchronization and high-precision analog to digital conversion (ADC) for detection as provided by the main radio of the receiving NR device. MWUS/NWUS enable energy saving at the receiving detector as they are of much shorter transmission duration carrying only a small number of bits compared to other data channels that typically need repetitions for coverage extension. However, the energy saving is still modest as the NR receiver still needs to be in deep sleep mode which is a significant part of the whole energy consumption of, e.g., a user equipment (UE). So far, the NWUS/MWUS feature does not seems to have been deployed in products by network operators.

Furthermore, current 3GPP Radio Access Network (RAN1) Rel-18 standardization is dedicating a study item on low power WUS (LP-WUS). It envisioned that significantly more power saving could be achieved if the main radio of a NR receiver could be totally switched off when no messages are coming. For this, an NR device would be equipped by an additional lower power detection receiver, named low-power wake-up receiver (LP-WUR). The WUR would monitor possible incoming traffic while the main radio can be totally switched off for a maximum power saving and only trigger it when necessary.

### SUMMARY

Embodiments of the present disclosure provide solutions which mitigates or solves the drawbacks and problems of conventional solutions.

Embodiments of the present disclosure provide a low complex on-off keying (OOK) signal which e.g., may be used as a WUS.

According to a first aspect of the present disclosure, the above mentioned solutions are achieved with a transmit device for a communication system, the transmit device being configured to:
spread a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle Φ;
multiply the N_{symb} number of modulation symbols with a discrete Fourier transform precoder to obtain N_{symb} number of Fourier coefficients; and
transmit an orthogonal frequency-division multiplexing, OFDM, signal comprising the N_{symb} number of Fourier coefficients mapped onto K number of OFDM subcarriers.

The transmit device may be part of or fully integrated in any suitable communication device configured for communications in a communication system. Further, the transmit device may also have the capability to receive communication signals in a communication system and not only the capability to transmit communication signals.

An advantage of the transmit device according to the first aspect is that a multi-bit OOK signal may be provided with lower complexity compared to conventional solutions. Further, flatter ON/OFF modulation states may also be provided thereby improving robustness against quantization error from low precision ADC at the receiver device. The transmit device according to the first aspect also makes it possible to better control the signal spectrum compared to conventional solutions.

In an implementation form of a transmit device according to the first aspect, spreading the N_{bit} number of bits is based on:
repeat the N_{bit} number of bits to obtain a sequence of N_{symb} number of repeated bits; and
multiply the N_{symb} number of repeated bits with a concatenated spreading sequence to obtain the N_{symb} number of modulation symbols, wherein the concatenated spreading sequence is a concatenation of the N_{bit} number of spreading sequences so that the concatenated spreading sequence is a linear phase sequence with constant rotational phase angle Φ.

An advantage with this implementation form is that the specification and implementation of a single concatenated spreading sequence may be simpler than specification and implementation of a sequence of N_{bit} number of spreading sequences.

In an implementation form of a transmit device according to the first aspect, the N_{bit} number of bits are Manchester encoded bits based on a sequence of N_{bit}/2 number of bits.

An advantage with this implementation form is that Manchester encoding enables, at the cost of halving the information rate, to have the transmitted signal with a constant energy level, and to remove the need for threshold determination for detection at the receiver device.

In an implementation form of a transmit device according to the first aspect, the spreading sequence rₗ[m] is given by the formula:

$${r}_{l} [ m ] = {e}^{j Φ m + {Φ}_{l}}$$

where l is a bit index, m is a modulation symbol index, e is the natural exponential function, j is the imaginary unit, and Φₗ is a constant angle that depends on the bit index l.

An advantage with this implementation form is that only the two angles Φ and Φₗ needs to be specified and stored in the transmit device to generate the spreading sequence.

In an implementation form of a transmit device according to the first aspect, the constant rotational phase angle Φ is equal to π.

An advantage with this implementation form is that such selection of phase angle minimizes the envelope fluctuation of OOK states.

In an implementation form of a transmit device according to the first aspect, the spreading sequence rₗ[m] is an alternating sequence of the values +1 and −1, respectively.

An advantage with this implementation form is that it is of very low complexity, and no computation, i.e., multiplication, is required for a sign change.

In an implementation form of a transmit device according to the first aspect, the spreading sequence rₗ[m] is an alternating sequence of two binary shift keying symbols.

An advantage with this implementation form is that it reuses constellation symbols already specified and implemented in 3GPP systems.

In an implementation form of a transmit device according to the first aspect, the constant rotational phase angle Φ is given by the formula:

$$Φ = 2 π ( \frac{{k}_{null}}{{N}_{s y m b}} + \frac{λ}{{N}_{s e g}} )$$

where N_{seg} is the length of the spreading sequence rₗ[m], kₙᵤₗₗ is an index for a nulled Fourier coefficient, and λ is any non-zero integer.

An advantage with this implementation form is that it enables to null a specific Fourier coefficient, i.e., to set the Fourier coefficient equal to zero, as for example the DC subcarrier which may be filtered out by the circuit of the receiver device.

In an implementation form of a transmit device according to the first aspect, the discrete Fourier transform precoder has size N_{symb}≤K.

An advantage with this implementation form is that the discrete Fourier transform (DFT) precoder size N_{symb} can be selected such that it is an integer factor of the number of the bit number N_{bit}, and as result each bit can be spread by the same spreading factor and thus transmitted with the same energy. Also, a DFT precoder size less than the WUS bandwidth K is of much less complexity than a typical OFDM inverse fast Fourier transform (IFFT) size. To further decrease the complexity the DFT precoder size N_{symb} may for example be selected to be a power of two.

In an implementation form of a transmit device according to the first aspect, the transmit device is configured to:
extend the N_{symb} number of Fourier coefficients into K number of Fourier coefficients based on a periodic repetition of the N_{symb} number of Fourier coefficients.

An advantage with this implementation form is that it enables to map the N_{symb} Fourier coefficients to a larger number of subcarriers K. Using more subcarriers enables generation of the OOK signal with sharper transition between the ON and OFF states, and less fluctuation inside the states. Using more subcarriers may also leverage frequency diversity to improve the detection at the receiver device.

In an implementation form of a transmit device according to the first aspect, the transmit device is configured to:
multiply the N_{symb} number of Fourier coefficients or the K number Fourier coefficients with frequency-domain spectral shaping window coefficients to obtain frequency-shaped Fourier coefficients.

An advantage with this implementation form is that frequency-domain spectral shaping will further flatten the OOK states which will improve robustness against detection errors.

In an implementation form of a transmit device according to the first aspect, the frequency-domain spectral shaping window coefficients are real valued symmetric coefficients from a bell-shaped function.

An advantage with this implementation form is that such FDSS windows are known to concentrate well in time the energy of DFT-s-OFDM pulses, which improves the shape of the OOK signal.

In an implementation form of a transmit device according to the first aspect, the frequency-domain spectral shaping window coefficients are Kaiser window coefficients with the shaping parameter β=2.

An advantage with this implementation form is that it provides a good least square approximation of an ideal OOK signal.

In an implementation form of a transmit device according to the first aspect, the frequency-domain spectral shaping window coefficients W₀[k] are given by the formula:

$${W}_{0} [ k ] = \{ \begin{matrix}\frac{sin ( \frac{π}{{N}_{symb}} ( \frac{K}{2} - k ) )}{sin ( \frac{π}{{N}_{fft}} ( \frac{K}{2} - k ) )} & k \neq \frac{K}{2} ; k = 0 , … , K - 1 \\ {N}_{fft} / {N}_{symb} & k = K / 2\end{matrix}$$

where N_{fft} is a number of samples of the OFDM signal, and sin( ) is the sinus function.

An advantage with this implementation form is that it corresponds to an optimum least square approximation of an ideal OOK signal.

In an implementation form of a transmit device according to the first aspect, the transmit device is configured to:
multiply the frequency-shaped Fourier coefficients with a frequency-domain phase shift to obtain phase shifted Fourier coefficients, wherein the frequency-domain phase shift is based on a shifting parameter T_{shift}.

An advantage with this implementation form is that it can improve the time location of the OOK states by maximizing the energy of the OOK states in their targeted time domain period.

In an implementation form of a transmit device according to the first aspect, a value of the shifting parameter T_{shift} is dependent on a number of samples of the OFDM signal N_{fft} and the N_{symb} number of modulation symbols.

An advantage with this implementation form is that it can be sufficient for controlling the time location discussed above as the OOK signal is constructed from multiplexing of N_{symb} time-domain pulses, spanning an OFDM signal of N_{fft} samples.

In an implementation form of a transmit device according to the first aspect, the value of the shifting parameter T_{shift} is given by any one of the formulas:

$${T}_{shift} = \frac{{N}_{f f t}}{2 {N}_{s y m b}}$$

$${T}_{shift} = \frac{{N}_{f f t}}{2 {N}_{s y m b}} - \frac{1}{2}$$

$${T}_{s h i f t} = ⌈ \frac{{N}_{f f t}}{2 {N}_{s y m b}} ⌉$$

$${T}_{s h i f t} = ⌊ \frac{{N}_{f f t}}{2 {N}_{s y m b}} ⌋$$

$${T}_{s h i f t} = round [ \frac{{N}_{f f t}}{2 {N}_{s y m b}} ]$$

where N_{fft} is the number of samples of the OFDM signal, ┌ ┐ is the ceiling function, └ ┘ is the floor function, and round[ ] is the rounding function.

An advantage with this implementation form is that it provides close to the best time localization, as it corresponds to half of the time difference between two consecutive time-domain pulses.

In an implementation form of a transmit device according to the first aspect, the OFDM signal is a wake-up signal.

According to a second aspect of the present disclosure, the above mentioned solutions are achieved with a method for a transmit device, the method comprising:
spreading a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle Φ;
multiplying the N_{symb} number of modulation symbols with a discrete Fourier transform precoder to obtain N_{symb} number of Fourier coefficients; and
transmitting an OFDM signal comprising the N_{symb} number of Fourier coefficients mapped onto K number of OFDM subcarriers.

The method according to the second aspect can be extended into implementation forms corresponding to the implementation forms of the transmit device according to the first aspect. Hence, an implementation form of the method comprises the feature(s) of the corresponding implementation form of the transmit device.

The advantages of the methods according to the second aspect are the same as those for the corresponding implementation forms of the transmit device according to the first aspect.

Embodiments of the present disclosure also relate to a computer program, characterized in program code, which when run by at least one processor causes the at least one processor to execute any method according to embodiments of the present disclosure. Further, embodiments of the present disclosure also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the present disclosure will be apparent from the following detailed description.

### BRIEF DESCRIPTION OF THE DRAWINGS

The appended drawings are intended to clarify and explain different embodiments of the present disclosure, in which:

FIG. 1 shows a transmit device according to an embodiment of the present disclosure;

FIG. 2 shows a flow chart of a method for a transmit device according to an embodiment of the present disclosure;

FIG. 3 shows a receiver device according to an embodiment of the present disclosure;

FIG. 4 shows a communication system according to an embodiment of the present disclosure;

FIG. 5 shows another block diagram of a transmit device according to embodiments of the present disclosure;

FIG. 6 shows OOK state flattening effect of the chosen linear phase ramp with the spreading sequence r[m], where 2-bit string [1 0] is transmitted with K=72 without FDSS;

FIG. 7 shows OOK state flattening effect of the chosen linear phase ramp in the spreading sequence r[m], where 8-bit string [1 0 0 1 1 0 1 0] is transmitted with K=72 and FDSS with β=4;

FIG. 8 shows difference between Eq. (21) and (22) and its approximation with Φ=π, where Manchester-encoded bit strings of length N_{bit0}=4 are transmitted with K=72, and FDSS with β=4 is used, FIG. 8(a) shows envelope for [1 0 0 1 1 0 1 0] and FIG. 8(b) shows average power of DFT coefficients;

FIG. 9 shows DC subcarrier nulling with N_{bit0}=4 and K=72 where FDSS with β=4 is used, FIG. 9(a) shows envelope for [1 0 0 1 1 0 1 0] and FIG. 9(b) shows average power of DFT coefficients;

FIG. 10 shows BER as a function of phase ramp angle Φ and different FDSS coefficients β, FIG. 10(a) shows for α_{BPF}=2 and Sₑ=128, and FIG. 10(b) shows for α_{BPF}=1 and Sₑ=64;

FIG. 11 shows BER as a function of SNR where in FIG. 11(a) Sₑ=128 and in FIG. 11(b) Sₑ=64;

FIG. 12 shows BER performance where the WUR analog circuit filters out the DC component;

FIG. 13 illustrates the time shift correction of OOK signal by FD phase shift;

FIG. 14 illustrates the benefit of the FD phase shift (TD cyclic shift), FIG. 14(a)

shows envelopes for [1 0 0 1 1 0 1 0], and FIG. 14(b) shows Manchester decoding after downsampling;

FIG. 15 shows BER performance for N_{bit0}=4 and α_{BPF}=1 with and without FD phase shift;

FIG. 16 shows PAPR as function as a function of phase ramp angle Φ and different FDSS coefficients β, FIG. 16(a) shows for K=24 Nₑ=0, and N_{bit0}=2, FIG. 16(b) shows for K=24, Nₑ=8, and N_{bit0}=8, FIG. 16(c) shows for K=72, Nₑ=0, and N_{bit0}=4, and FIG. 16(d) shows for K=72, Nₑ=8, and N_{bit0}=8;

FIG. 17 shows representation of TD pulse multiplexing; and

FIG. 18 shows the benefit of spectrum extension in creating an equal spreading factor per bit.

### DETAILED DESCRIPTION

In order to achieve a very low-power consumption, WUR may better use a simple non-coherent envelop detector and as a result WUS using OOK modulation is considered well-suited. OOK modulates bits by two amplitude values, typically denominated as states ON and OFF, as depicted in Table 1, below. In practice, the amplitude values of the signal states fluctuate and depend on the pulse shaping. Ideally, the OFF state would have a constant amplitude value of 0 and the ON state would have a constant amplitude of A≠0, often assumed A=1 by convention.

TABLE 1
Simple OOK

| Info bits | States |
|---|---|
| 1 | ON |
| 0 | OFF |

As all current NR channels/signals use OFDM modulation, it would be desirable that a legacy OFDM-based NR transmitter could generate the WUS, even if it uses a different waveform such as OOK. Moreover, it would be desirable that the WUS could be directly orthogonally frequency-multiplexed with other concurrent OFDM transmissions without interfering with them. To achieve this, the WUS should be generated based on OFDM by populating some dedicated subcarriers. Therein, a set of, say K, subcarriers for WUS are multiplexed with subcarriers carrying other data symbols. They may be processed together with N_{fft}-point IFFT before the addition of a cyclic prefix (CP).

Formally, a transmitted OFDM signal s[n] is a superposition of WUS s^{W}[n] and a data signal s^{D}[n] generated with a single OFDM modulation. One CP-OFDM symbol with sample indices−N_{CP}≤n≤N_{fft}−1 is computed as (any normalization coefficient is omitted for simplicity)

$$s [ n ] = {s}^{W} [ n ] + {s}^{D} [ n ] = {\sum }_{k = 0}^{{N}_{fft} - 1} X [ k ] {e}^{j \frac{2 π}{{N}_{fft}} nk} \qquad ( 1 )$$

$$where$$

$$X = \{ {\underbrace{{X}^{D} [ 0 ] , … , {X}^{D} [ {K}_{0} - 1 ]}}_{data} , {\underbrace{{X}^{W} [ 0 ] , … , {X}^{W} [ K - 1 ]}}_{WUS} , \\ {\underbrace{{X}^{D} [ {K}_{0} + 1 ] , … , {X}^{D} [ {K}_{1} - 1 ]}}_{data} \} \qquad ( 2 )$$

$$such that$$

$$X = {\tilde{X}}^{W} + {\tilde{X}}^{D} \qquad ( 3 )$$

$$with$$

$${\tilde{X}}^{D} = \{ {X}^{D} [ 0 ] , … , {X}^{D} [ {K}_{0} - 1 ] , {\underbrace{0 , … , 0}}_{K subcarriers} , {X}^{D} [ {K}_{0} ] , … , {X}^{D} [ {K}_{1} - 1 ] \} \qquad ( 4 )$$

$$and$$

$${X}^{W} = \{ {\underbrace{0 , … , 0}}_{{K}_{0} subcarriers} , {X}^{W} [ 0 ] , … , {X}^{W} [ K - 1 ] , {\underbrace{0 , … , 0}}_{{K}_{1} - {K}_{0} subcarriers} \} \qquad ( 5 )$$

The WUS can thus be expressed as

$${s}^{W} [ n ] = {e}^{j \frac{2 π}{{N}_{fft}} n {K}_{0}} \times {\sum }_{k = 0}^{{N}_{s c} - 1} {X}^{W} [ k ] {e}^{j \frac{2 π}{{N}_{fft}} n k} . \qquad ( 6 )$$

Unless otherwise mentioned, assume N_{fft}=2048 with CP length N_{CP}=144 which is a common 3GPP numerology, but the embodiments disclosed herein are not limited thereto.

Thus, embodiments of the present disclosure include a scalable OOK-OFDM WUS waveform compatible with 3GPP NR transmitters and reusing already legacy components of 3GPP signals. Embodiments of the present disclosure include a solution with low complexity compared to conventional solutions.

Thus, embodiments of the present disclosure enable use of bit-spreading sequences in order to control the shape of the signal waveforms and/or its spectrum. Although an application included herein is for WUS transmissions in 3GPP NR, embodiments of the present disclosure are not limited thereto. Embodiments of the present disclosure also provide spreading sequences that enable very flat envelope of the ON and OFF states of the signal thereby providing robustness against detection errors due to noise and fading when using a low-precision ADC envelope detector at a receiver device.

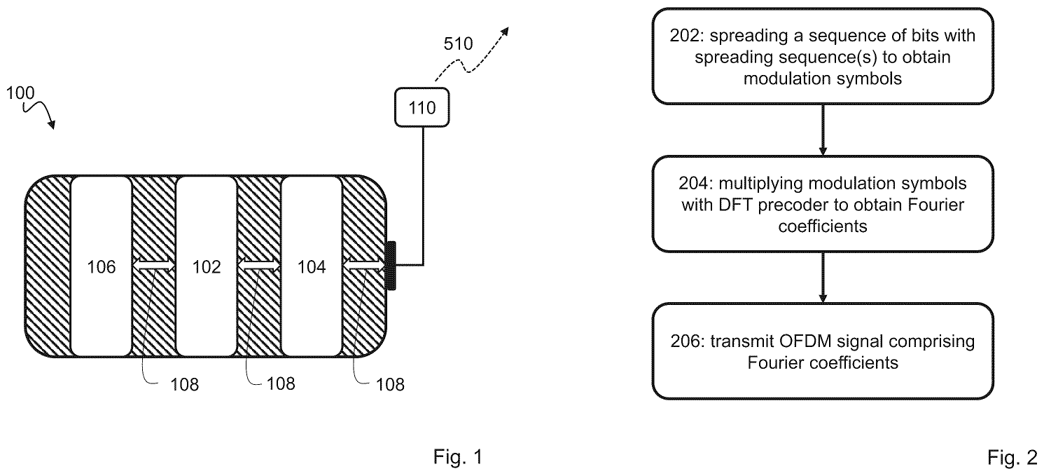

FIG. 1 therefore shows a transmit device 100 according to an embodiment of the present disclosure. In the embodiment shown in FIG. 1, the transmit device 100 comprises a processor 102, a transceiver 104 and a memory 106. The processor 102 is coupled to the transceiver 104 and the memory 106 by communication means 108 known in the art. The transmit device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset. That the transmit device 100 is configured to perform certain actions can in this disclosure be understood to mean that the transmit device 100 comprises suitable means, such as e.g., the processor 102 and the transceiver 104, configured to perform the actions.

According to embodiments of the present disclosure the transmit device 100 is configured to spread a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle. The transmit device 100 is further configured to multiply the N_{symb} number of modulation symbols with a discrete Fourier transform precoder to obtain N_{symb} number of Fourier coefficients. The transmit device 100 is further configured to transmit an orthogonal frequency-division multiplexing, OFDM, signal 510 comprising the N_{symb} number of Fourier coefficients mapped onto K number of OFDM subcarriers.

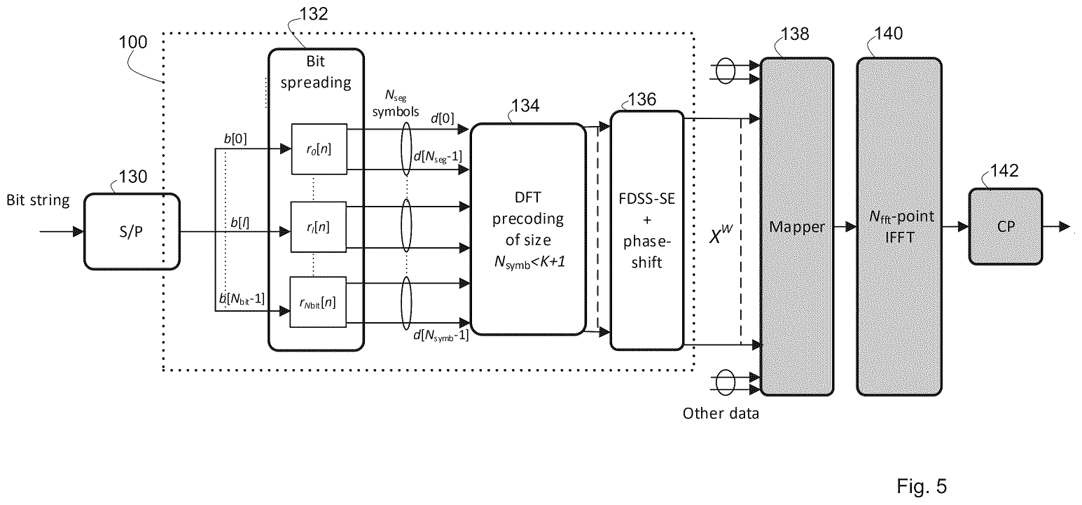

In an embodiment of the present disclosure, the transmit device 100 for a communication system 500 (of FIG. 4) comprises a processor configured to: spread a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle Φ; and multiply the N_{symb} number of modulation symbols with a discrete Fourier transform precoder to obtain N_{symb} number of Fourier coefficients. The transmit device 100 further comprises a transceiver configured to transmit an orthogonal frequency-division multiplexing, OFDM, signal 510 comprising the N_{symb} number of Fourier coefficients mapped onto K number of OFDM subcarriers.

In an embodiment of the present disclosure, the transmit device 100 for a communication system 500 comprises a processor and a memory having computer readable instructions stored thereon which, when executed by the processor, cause the processor to: spread a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle Φ; multiply the N_{symb} number of modulation symbols with a discrete Fourier transform precoder to obtain N_{symb} number of Fourier coefficients; and transmit an orthogonal frequency-division multiplexing, OFDM, signal 510 comprising the N_{symb} number of Fourier coefficients mapped onto K number of OFDM subcarriers.

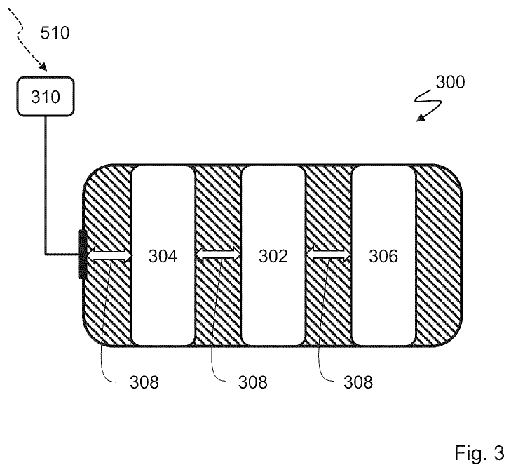

FIG. 2 shows a flow chart of a corresponding method 200 which may be executed in a transmit device 100, such as the one shown in FIG. 1. The method 200 comprises spreading 202 a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle Φ. The method 200 comprises multiplying 204 the N_{symb} number of modulation symbols with a discrete Fourier transform precoder to obtain N_{symb} number of Fourier coefficients. The method 200 comprises transmitting 206 an OFDM signal 510 comprising the N_{symb} number of Fourier coefficients mapped onto K number of OFDM subcarriers.

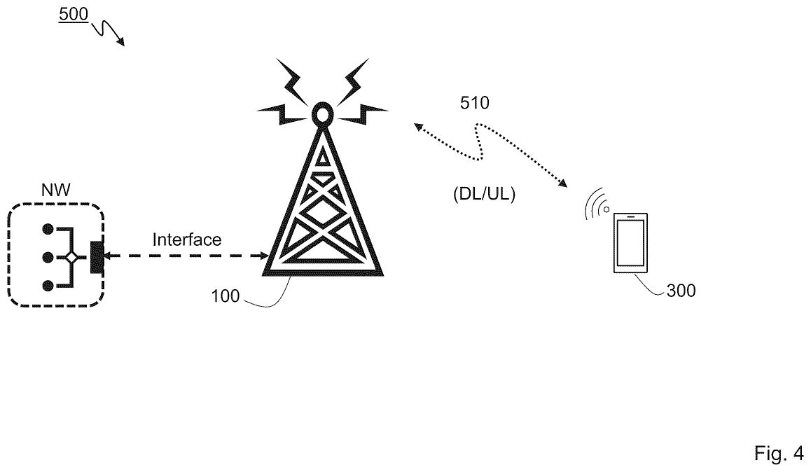

FIG. 3 shows a receiver device 300 according to an embodiment of the present disclosure. In the embodiment shown in FIG. 3, the receiver device 300 comprises a processor 302, a transceiver 304 and a memory 306. The processor 302 is coupled to the transceiver 304 and the memory 306 by communication means 308 known in the art. The receiver device 300 further comprises an antenna or antenna array 310 coupled to the transceiver 304, which means that the receiver device is configured for wireless communications in a communication system.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset. That the receiver device 300 is configured to perform certain actions can in this disclosure should be understood to mean that the receiver device 300 comprises suitable means, such as e.g., the processor 302 and the transceiver 304, configured to perform the actions.

According to embodiments of the present disclosure, the receiver device 300 is configured to receive the OFDM signal 510 transmitted by the transmit device 100. The OFDM signal 510 is due to the bit spreading according to embodiments of the present disclosure as an OOK signal. The receiver device 300 will therefore decode the bits of the OOK signal by non-coherent detection of the envelope fluctuation of the OOK signal. A typical low-power wake-up receiver architecture for OOK signal detection is to first process the received signal 510 in the analog domain by low-pass filtering for interference rejection and noise reduction, and then directly perform envelope detection. Then this processed signal is sampled and converted to the digital domain before bit detection is performed. If the detected bit string corresponds to a specific bit string implemented in the receiver device 300, the receiving unit of the receiver device 300 for WUS detection triggers a wake-up of other radio units of the receiver device 300 if the OFDM signal 510 is a WUS.

FIG. 4 shows a communication system 500, such as 3GPP NR, according to embodiments of the present disclosure. The communication system 500 in the disclosed embodiment comprises a transmit device 100 and a receiver device 300 configured to communicate and operate in the communication system 500. In the non-limiting example, the transmit device 100 may be part of a network access node, such as a base station, while the receiver device 300 may be part of a client device, such as a UE. The network access node may be connected to a core network of the communication system via a communication interface.

Thus, the network access node and the client device are configured to communicate in the downlink (DL) and uplink (UL) which implies that the network access node may transmit an OFDM signal 510 comprising N_{symb} number of Fourier coefficients mapped onto K number of OFDM subcarriers generated according to embodiments of the present disclosure. Further details related to embodiments of the present disclosure will be described in a 3GPP 5G NR context. Thus, 3GPP 5G terminology, definitions, expressions and system architecture will be used. It should be understood that embodiments of the present disclosure are not limited thereto.

In general terms, embodiments of the present disclosure may be considered to be based on inherent time-domain multiplexing property of DFT-precoded OFDM, similar as DFT-s-OFDM already standardized in NR. For WUS applications, the DFT-precoder is of size N_{symb}≤K, i.e., no more than the number of subcarriers in the WUS bandwidth allocation but the DFT-precoder may have another size in other applications than WUS. Each bit is spread and mapped to a sequence of modulation symbols before DFT-precoding.

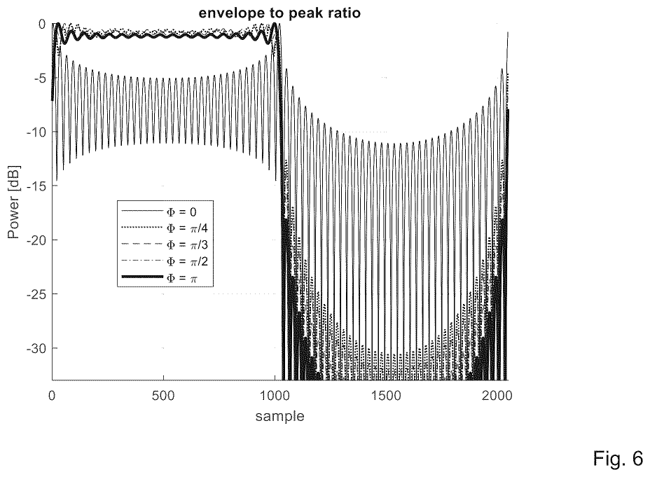

FIG. 5 illustrates a block diagram of a transmit device 100 integrated in a processing chain of a general communication device according to embodiments of the present disclosure. A serial to parallel (S/P) block 130 is connected to an input of the transmit device 100. A bit string is converted to N_{bit} parallel bits in the S/P block 130. The bit string b[l], l=0, . . . , N_{bit}−1 where b[l]∈{0,1} is taken as input to the transmit device 100 after being converted to parallel bits.

The parallel bits are provided to the spreader block 132 where the N_{bit} number of bits are multiplexed together such that each bit b[l] is multiplied by a spreading sequence rₗ[n] of length N_{seg} to generate N_{seg} corresponding modulation symbols of total N_{symb}=N_{bit}N_{seg} modulation symbols. The bits are spread by a factor N_{seg} to obtain a sequence of N_{symb}=N_{bit}N_{seg} modulation symbols as follows.

Each individual bit b[l], l=0, . . . , N_{bit}−1, is multiplied with a spreading sequence rₗ[n], n=0, . . . , N_{seg}−1, such that the modulation symbols are given by

$$d [ m ] = b [ {l}_{m} ] {r}_{{l}_{m}} [ m - {N}_{s e g} {l}_{m} ] , \qquad ( 7 )$$

where m=0, . . . , N_{symb}1 and

$${l}_{m} = ⌊ \frac{m}{{N}_{s e g}} ⌋ .$$

It may be noted that each individual spreading sequences rₗ[n] are dependent on the bit index l. This is important as consecutive symbols transmitting different bits which will interact with each other.

In embodiments of the present disclosure, the individual spreading sequences rₗ[n] may be concatenated into a so-called concatenated spreading sequence r[m], m=0, . . . , N_{symb}−1, as

$$r = \{ {r}_{0} [ 0 ] , … , {r}_{0} [ {N}_{s e g} - 1 ] , … , {r}_{{N}_{b i t} - 1} [ 0 ] , … , {r}_{{N}_{b i t} - 1} [ {N}_{s e g} - 1 ] \} \qquad ( 8 )$$

Thus, Eq. (7) can be written as

$$d [ m ] = b [ {l}_{m} ] r [ m ] . \qquad ( 9 )$$

Accordingly, the modulation symbols can be obtained by spreading the bits by simple repetition to obtain a repeated bit string bᵣ[m]=b[[m/N_{seg}]] of length N_{symb}=N_{bit}N_{seg} and thereafter the repeated bit string bᵣ[m] is element-wise multiplied with the concatenated spreading sequence r[m]. Thus, in embodiments of the present disclosure, the transmit device 100 is configured to spread the N_{bit} number of bits based on repeating the N_{bit} number of bits to obtain a sequence of N_{symb} number of repeated bits. Thereafter, the transmit device 100 multiplies the N_{symb} number of repeated bits with the concatenated spreading sequence to obtain the N_{symb} number of modulation symbols. The concatenated spreading sequence r[m] will be a concatenation of the N_{bit} number of spreading sequences so that the concatenated spreading sequence r[m] is a linear phase sequence with constant rotational phase angle Φ as previously mentioned. The following description shows in more detail how to construct the concatenated spreading sequence r[m] and therefore also the individual spreading sequences rₗ[n] in order to control the shape of the OFDM signal 510 as an OOK signal and the spectrum thereof.

The modulation symbols as output from the spreader block 132 are provided to the DFT precoding block 134 in FIG. 5 and thus converted from modulation symbols to Fourier coefficients. The modulations symbols are DFT-precoded in the DFT precoding block 134 to provide a sequence of Fourier coefficients

$$D [ k ] = {\sum }_{m = 0}^{{N}_{s y m b} - 1} d [ m ] {e}^{- j \frac{2 π}{{N}_{s y m b}} k m} , for k = 0 , … , {N}_{s y m b} - 1. \qquad ( 10 )$$

Before mapping the Fourier coefficients to K number of subcarriers, the output of the DFT block 134 may be fed to a signal processing block 136 which extends, shapes and shifts the phase of the Fourier coefficients.

Before mapping the Fourier coefficients to the K OFDM subcarriers, the Fourier coefficients of the DFT-precoder 134 may be provided to an optional signal processing block 136 where the Fourier coefficients are expanded by spectrum extension (SE) to meet the subcarrier allocation K, and a frequency-domain spectral shaping (FDSS) window and a phase shift also may also be considered to achieve further shaping effects on the OFDM signal for improved performance. This structure is of much lower implementation complexity than conventional solutions as the DFT precoder size is at most equal to the number of subcarriers in the WUS bandwidth allocation, which is typically much smaller than the IFFT size of OFDM.

### SE

The size N_{symb} of the DFT-precoder needs to be such that the spreading factor N_{seg}=N_{symb}/N_{bit} is an integer. To achieve this, instead of having N_{symb}=K as commonly done in DFT-s-OFDM, the discrete Fourier transform precoder has a size N_{symb}≤K. In an example the N_{symb} number of Fourier coefficients are extended into K number of Fourier coefficients based on a periodic repetition of the N_{symb} number of Fourier coefficients.

Given a subcarrier allocation of K subcarriers, the size of the DFT precoder N_{symb} is selected such that N_{symb}≤K and N_{symb}/N_{bit} is an integer, for example the largest possible one, and if needed populate the K subcarriers by SE as

$${D}^{( s e )} [ k ] = D [ k + L ( mod {N}_{s y m b} ) ] , for k = 0 , … , K - 1. \qquad ( 11 )$$

where L is an integer shift. Often, one can select N_{symb}=K, and SE is not needed and D^{(se)}[k]=D[k]. Otherwise, a relevant case is to select N_{symb} such that Nₑ=(K−N_{symb}) is even and then to select L=−Nₑ/2 (mod N_{symb}) as this shift has the benefit to create a symmetric spectrum. This can be written as

$${D}^{( s e )} = \{ D [ {N}_{s y m b} - \frac{{N}_{e}}{2} ] , … , D [ {N}_{symb} - 1 ] , \\ D [ 0 ] , … , D [ {N}_{s y m b} - 1 ] , D [ 0 ] , … , D [ \frac{{N}_{e}}{2} - 1 ] \} . \qquad ( 12 )$$

The SE also enables modification of the number of resulting DFT-s-OFDM time-multiplexing pulses that constitute the OFDM signal. The fewer pulses, the wider they are, and so it gives additional degrees of freedom to modify the overall signal shaping. In conventional solutions, SE has been used as a way to decrease peak to average power ratio (PAPR) as the cost of breaking the orthogonality among the pulses, which amounts to increasing the inter-pulse interference. The motivation for using SE in the present solution is different and is used for controlling the spreading factor. Moreover, for the purpose of creating an OOK signal, there is no benefit of preserving the orthogonality among the pulses.

### FDSS

After SE a FDSS may be applied on the Fourier coefficients as

$${X}^{′} [ k ] = W [ k ] {D}^{( s e )} [ k ] \qquad ( 13 )$$

where {W[0], . . . , W[K−1]} are the FDSS window coefficients. FDSS enables to further shape the OOK waveform. Thus, the N_{symb} number of Fourier coefficients or the K number Fourier coefficients are multiplied with FDSS window coefficients to obtain frequency-shaped Fourier coefficients.

Relevant embodiments of FDSS windows are low-PAPR windows which are typically real and symmetric and whose coefficients are derived from a Bell-shape function. Such windows mitigate further the fluctuation of the signal's envelope, thus flattening the OOK states.

In embodiments of the present disclosure, the FDSS window coefficients are Kaiser window coefficients with shaping parameter β, due to its convenient parametrization. Such window coefficients have also been shown to concentrate the energy well of DFT-s-OFDM in the time-domain (TD) which is relevant for the OOK signal design. The shaping parameter may be equal to 2, i.e., β=2. It may be noted that the case β=0 gives a rectangular window and is thus equivalent to have no FDSS at all.

Other types of FDSS windows are possible such as so-called truncated root-raised-cosine (RRC) filters with for example parameters (0.5, −0.65) or (0.5, 0.1667); 2-tap filters with for example coefficients [1 −0.28]; 3-tap filters with for example coefficients [−0.335 1 −0.335] or [−0.28 1 −0.28]. Thus, in embodiments, the FDSS window coefficients are instead given by the formula:

$${W}_{0} [ k ] = \{ \begin{matrix}\frac{sin ( \frac{π}{{N}_{symb}} ( \frac{K}{2} - k ) )}{sin ( \frac{π}{{N}_{fft}} ( \frac{K}{2} - k ) )} & k \neq \frac{K}{2} ; k = 0 , … , K - 1 \\ {N}_{fft} / {N}_{symb} & k = K / 2\end{matrix}$$

where N_{fft} is a number of samples of the OFDM signal 510, and sin( ) is the sinus function.

### FDs Phase Shift

A frequency-domain (FD) phase shift may also be applied on the Fourier coefficients to further shape the signal. Thus, the frequency-shaped Fourier coefficients may be multiplied with a FD phase shift to obtain phase shifted Fourier coefficients, where the FD phase shift is based on a shifting parameter T_{shift}.

In examples the FD phase shift may be applied on the Fourier coefficients as

$${X}^{W} [ k ] = {e}^{- \frac{j 2 π}{{N}_{fft}} {T}_{shift}^{k}} {X}^{′} [ k ] . \qquad ( 14 )$$

in order to create a TD circular shift on the WUS s^{W}[n] in Eq. (6). This step is used to cyclic shift the OOK signal such that the time location of the OOK states is improved by maximizing the energy of the OOK states in their targeted time domain period. As discussed herein, the WUS s^{W}[n] becomes equivalent to the TD pulse multiplexing in Eq. (31). Without the shift in Eq. (14), the first pulse g₀[n] carrying the first modulation symbol d[0] has a peak at time index 0 and its energy split equally between the beginning and the end of the OFDM symbol by circularity. This operation shifts all pulses such that the first pulse has its energy mainly at the beginning of the OFDM symbol. However, as only the WUS signal should be shifted and not concurrent data, an FD implementation of this TD cyclic shifting may be required. In case there is no other multiplexed data, neither FDSS nor SE, this operation could be implemented by TD cyclic-shift before CP addition. This implies that the value of the shifting parameter T_{shift} is dependent on a number of samples of the OFDM signal 510 N_{fft} and the N_{symb} number of modulation symbols.

Relevant embodiments correspond to cyclic shift a pulse by half of the time difference between two consecutive pulses, i.e., approximately

$${T}_{shift} = \frac{{N}_{fft}}{2 {N}_{symb}} .$$

As a result, the first and last samples of the OFDM signal are in-between the first and last pulses. Small variations such as

$${T}_{shift} = \frac{{N}_{fft}}{2 {N}_{symb}} - \frac{1}{2}$$

and integer approximation such as variations such as

$${T}_{shift} = ⌈ \frac{{N}_{fft}}{2 {N}_{symb}} ⌉ or ⌊ \frac{{N}_{fft}}{2 {N}_{symb}} ⌋$$

also provides similar effects. Hence, the value of the shifting parameter T_{shift} may be given by any one of the formulas:

$${T}_{shift} = \frac{{N}_{fft}}{2 {N}_{symb}}$$

$${T}_{shift} = \frac{{N}_{fft}}{2 {N}_{symb}} - \frac{1}{2}$$

$${T}_{shift} = ⌈ \frac{{N}_{fft}}{2 {N}_{symb}} ⌉$$

$${T}_{shift} = ⌊ \frac{{N}_{fft}}{2 {N}_{symb}} ⌋$$

$${T}_{shift} = round [ \frac{{N}_{fft}}{2 {N}_{symb}} ]$$

where N_{fft} is the number of samples of the OFDM signal 510, ┌ ┐ is the ceiling function, └ ┘ is the floor function, and round[ ] is the rounding function. Larger values of T_{shift} may also be considered as for example

$${T}_{shift} \approx \frac{{N}_{fft}}{{N}_{symb}}$$

in order to further reduce the energy leakage of the first time-multiplexing pulse to the end of the OFDM symbol. To avoid that the last time-multiplexing pulse will have its energy leaking in the beginning of the OFDM symbol, the last pulse can be used as a guard pulse by setting the corresponding last input of the DFT precoder systematically to zero.

By merging Eqs. (11), (13) and (14) together, the signal processing block 136 transforms the output of the DFT block 134, which are the Fourier coefficients D[k], k=0, . . . , N_{symb} as given in Eq. (10), to the following WUS Fourier coefficients

$${X}^{W} [ k ] = W [ k ] D [ k + L ( mod {N}_{symb} ) ] {e}^{- \frac{j 2 π}{{N}_{fft}} {T}_{shift}^{k}} ,$$

$$for k = 0 , … , K .$$

Furthermore, the mapper block 138 maps the WUS Fourier coefficients from the signal processing block 136 to the K allocated subcarriers for WUS. Other data as formulated in Eq. (2) may be inputted to the mapper block 138, such as other WUS or other types of data for other receiving devices, to be frequency-multiplexed together within the same OFDM symbol. The output of the mapper block 138 are fed to the OFDM IFFT block 140 thereby generating a time-domain OFDM symbol. Finally, a CP block 142 adds a cyclic prefix to the OFDM signal before transmission in the communication system.

### Manchester Encoding

OOK modulation is typically performed after an optional Manchester encoding of the information bits. A Manchester encoding scheme is shown in Table 2.

TABLE 2
Manchester encoded OOK

| Info bits | Encoded bits | States |
|---|---|---|
| 1 | 1 0 | ON OFF |
| 0 | 0 1 | OFF ON |

Manchester coding creates a bit string with a constant average of ½. An advantage with this is that the envelope of the modulated OOK signal will have a constant DC component that does not carry any information. Therefore, the optimal threshold for detection is found by estimation of this DC component. Ideally, the DC level of the envelope could be estimated and subtracted, so that the decision boundary for WUS is zero. Nevertheless, due to fading in wireless transmissions, such threshold selection typically does not perform well as ambiguous decoding states such ‘0 0’ or ‘1 1’ may occurred. A better approach that exploits Manchester encoding principle is to compare the amplitude of a first signal state with the amplitude of a second signal state to obtain the information bits. It may be noted that Manchester-encoded OOK is a form of pulse-position modulation (PPM), and the disclosed solution herein could be directly adapted to transmit any OFDM-based pulse-position modulation.

Therefore, in embodiments of the present disclosure, the bit string to be spread is a Manchester encoded version of an original bit string of length N_{bit0} such that N_{bit}=2N_{bit0}, or equally, the N_{bit} number of bits are Manchester encoded bits based on a sequence of N_{bit}/2 number of bits. The number of modulation symbols per info bits (before encoding) is then 2N_{seg} which serves at creating both for each bit an ON state and an OFF state. With N_{symb}=K, it is possible that the number of modulation symbol per OOK state, i.e., the spreading factor

$${N}_{seg} = \frac{K}{{N}_{bit}} ,$$

is not an integer. However, with Manchester encoding it is possible that the number of modulation symbols per info bit

$$2 {N}_{seg} = \frac{K}{{N}_{b i t 0}}$$

is an integer even though N_{seg} is not. As a result instead of using SE to obtain an integer value for N_{seg}, one could consider to allocate two different spreading factors for “0” and “1” bits, i.e., N_{segOFF} and N_{segON}, respectively, such that N_{segOFF}+N_{segON}=2N_{seg} hold and thus N_{symb}=N_{bit0}(N_{segOFF}+N_{segON}). It is shown that using SE provides a better performance, nevertheless the disclosed embodiments are directly generalizable to the case of two different spreading factors for ON and OFF states.

As previously mentioned, the spreading sequence r[m] herein used will enable controlling the signal shape and spectrum. For this a constant envelope sequence is used as the concatenated spreading sequence r[m] according to the expression

$$r [ m ] = {e}^{j {ϕ}_{m}} . \qquad ( 15 )$$

The modulated symbols then become

$$\begin{matrix}d [ m ] = b [ {l}_{m} ] r [ m ] \\ = b [ ⌊ m / {N}_{seg} ⌋ ] {e}^{j {ϕ}_{m}} .\end{matrix} \qquad ( 16 )$$

Equivalently, each individual spreading sequences rₗ[n] in Eq. (7) will be equal to

$${r}_{l} [ n ] = {e}^{j {ϕ}_{{lN}_{seg} + n}} . \qquad ( 17 )$$

Thus, an individual spreading sequence rₗ[m] is given by the formula rₗ[m]=e^{jΦm} where l is a bit index, m is a modulation symbol index, e is the natural exponential function, and j is the imaginary unit.

Additionally, the phases of the concatenated spreading sequence r[m] may be restricted to follow a linear phase with a rotation phase angle, i.e.,

$${ϕ}_{m} = Φ m + {Φ}_{0} for m = 0 , … , {N}_{symb} - 1 \qquad ( 18 )$$

where Φ and Φ₀ are constant angles. The constant Φ₀ impacts only the global phase of the signal and may be irrelevant from the point-of-view of a receiver with a non-coherent detector; therefore, unless otherwise mentioned consider Φ₀=0. As a result, each individual spreading sequence in Eq. (17) becomes a linear-phase sequence as rₗ[n]=e^{jΦn+Φ}^{ₗ} with rotation phase angle Φ and where Φₗ=ΦlN_{seg}+Φ₀ is a constant angle that depends of the bit index l but is independent of the modulation symbol index m.

An embodiment of the present disclosure includes selecting the same spreading sequence for each bit, which corresponds to set the constant angle Φₗ to zero resulting in a linear phase sequence rₗ[n]=e^{jΦn} independent of the bit index. While such a solution can often retain most of the advantages, it can be observed from simulation that this solution is suboptimal. Notably because this enables controlling the coherent combining of the TD multiplexing pulses inside each OOK state but not among consecutive OOK states.

The modulated symbols using Eq. (18) with Φ₀=0, Eq. (16) becomes

$$d [ m ] = b [ ⌊ m / {N}_{s e g} ⌋ ] {e}^{j Φ m} . \qquad ( 19 )$$

In the present disclosure, it is shown that the best constant rotational phase angle Φ for providing flat ON/OFF states is

$$Φ = π . \qquad ( 20 )$$

This is equivalent to have bit spreading by a sequence of alternating +1 and −1, explicitly Eq. (14) reduces to r[m]=(−1)^{m}. Thus, an individual spreading sequence rₗ[m] is in this case an alternating sequence of the values +1 and −1, respectively. Equivalently also to Eq. (19) is to spread each bit individually as in Eq. (16) by rₗ[n]=(−1)^{lN}^{_{seg}}⁺ⁿ, i.e., using the same spreading sequence

$${r}_{0} = {\underbrace{[ + 1 , - 1 , + 1 , … ]}}_{{N}_{s e g}}$$

for each bit up to a sign change as in

$${r}_{l} = {( - 1 )}^{{lN}_{seg}} {r}_{0} .$$

An alternating sequence of +1 and −1 can be interpreted as an alternating sequence of two binary phase-shift keying (BPSK) constellation symbols. Note that BPSK constellation in 3GPP standard is specified as

$$\{ \frac{1 + j}{√ 2} , \frac{- 1 - j}{√ 2} \} ,$$

i.e., it's the constellation {+1, −1} rotated by π/4. Therefore, it may be relevant to select Φ₀=π/4 in order to transform the above discussed sequence of +1 and −1 to a spreading sequence of alternating two BPSK symbols as specified in 3GPP, as for example

$${r}_{0} = {\underbrace{[ \frac{1 + j}{√ 2} , \frac{- 1 - j}{√ 2} , \frac{1 + j}{√ 2} , … ]}}_{{N}_{seg}} .$$

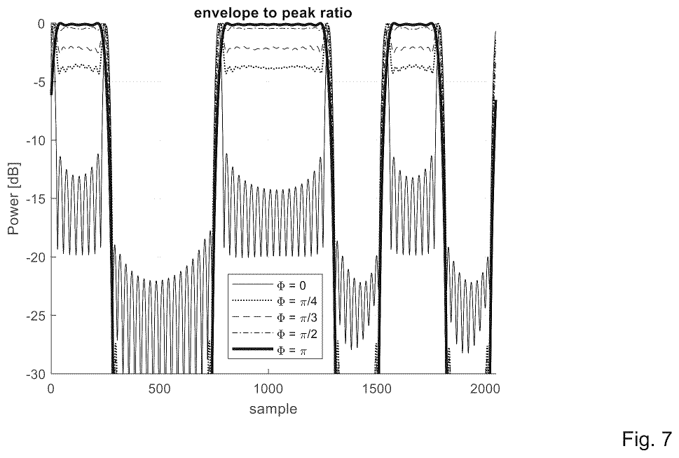

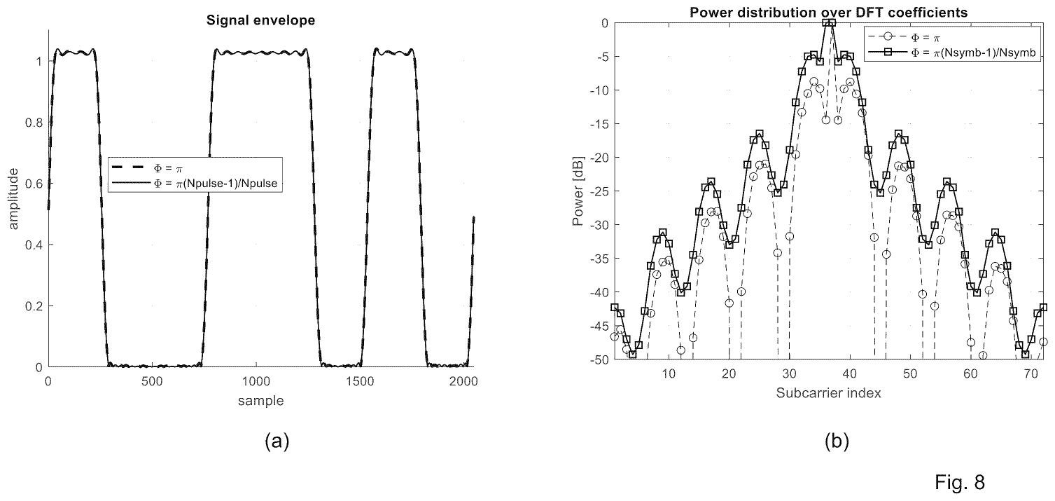

Embodiments of the present disclosure provide very low implementation complexity and follow from minimizing the phase difference between the overlapping lobes of two neighboring pulses. The analysis provided herein is only approximative in the sense it only considers two neighboring pulses while other neighboring pulses also contribute to the fluctuation of the state's envelopes. The analysis gets more relevant when increasing the shaping from an FDSS window as then other sidelobes are getting more and more attenuated. FIGS. 6 and 7 illustrate the obtained signal shapes according to different angles used in the linear phase ramp. Without FDSS, several angles such as Φ=π/3, π/2 or π provides ON states with similar fluctuation, but Φ=π provides slightly less energy leakage in the OFF states. With an FDSS, both ON and OFF states get clearly more constant when Φ is closer π.

It is shown herein that minimizing the phase difference between the overlapping lobes of two neighboring pulses can be achieved by selecting the phase ramp of the concatenated spreading sequence r[m] as

$$Φ = \frac{π}{{N}_{symb}} ( 2 L + K - 1 ) \qquad ( 21 )$$

which is in practice is well approximated by the value π. Notably, in the case of no SE, N_{symb}=K and L=0 and

$$Φ = \frac{π ( {N}_{symb} - 1 )}{{N}_{symb}} \approx π \qquad ( 22 )$$

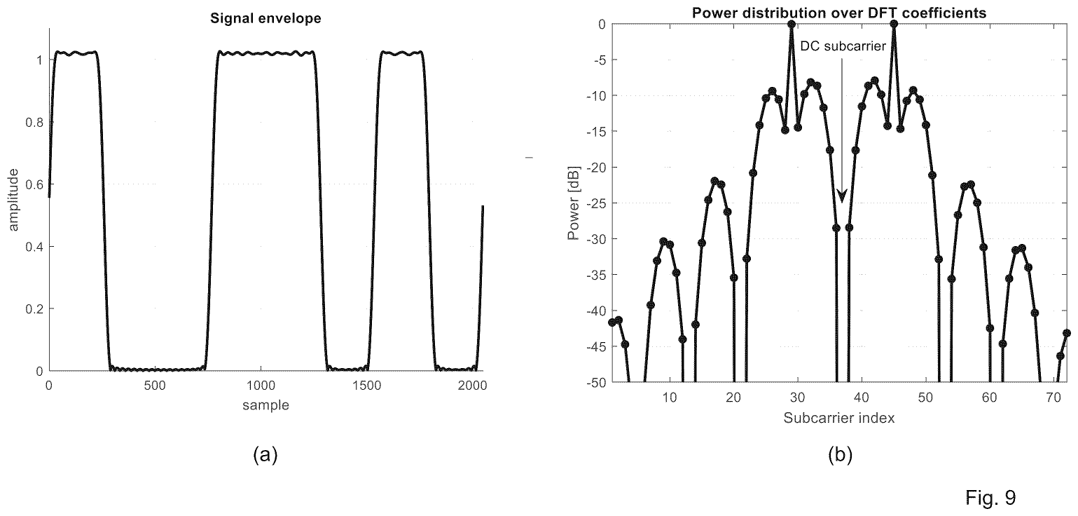

Numerical evaluation using Φ=π instead of Eq. (21) and (22) provides almost unnoticeable difference in the waveform shapes, but still corresponds to different values of Fourier coefficients as shown in FIG. 8. However, it can be observed that Fourier coefficients have often some nulls when selecting Φ=π/M where M is an integer that relates the number of bits per OFDM symbols as well as the number of symbols to modulate the ON and OFF states. If this is not desirable, this can easily circumvented be by using a small deviation from these angles as in Eq. (21) and (22) compared to Φ=π without impacting the waveform shapes, as shown in FIG. 8.

### Nulling a Subcarrier

An embodiment of the present disclosure includes choosing a linear phase of the concatenated spreading sequence r[m] that enables to null a specific subcarrier. For example, in the design of Wifi WUS the direct current (DC) subcarrier was selected to be 0 in case it is filtered out by the WUR circuit. It is shown herein that the output of DFT precoding of Eq. (10) with index kₙᵤₗₗ∈{0, . . . , N_{symb}−1} can be nulled i.e., D[kₙᵤₗₗ]=0, if N_{seg}>1 and by selecting the constant rotation phase angle equal to the formula

$$Φ = 2 π ( \frac{{k}_{null}}{{N}_{symb}} + \frac{λ}{{N}_{seg}} ) \qquad ( 24 )$$

where λ is any non-zero integer, for example λ=1 or λ=−1. For nulling the DC subcarrier, the middle index kₙᵤₗₗ=└N_{symb}/2┘ may be chosen.

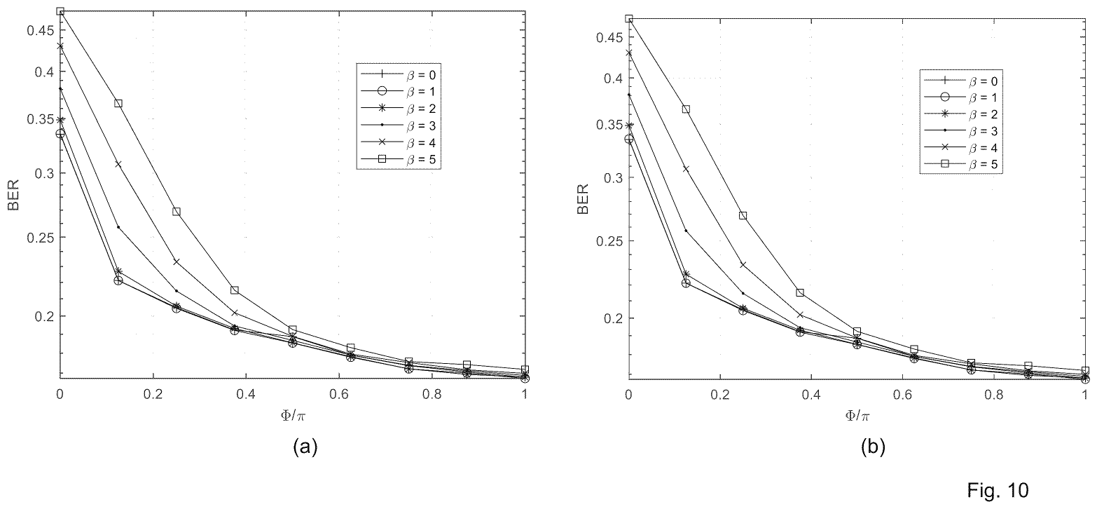

In FIG. 9, it is verified that the subcarrier nulling effect obtained with K=N_{symb}=72, N_{bit0}=4, and considering nulling index kₙᵤₗₗ=36. We have N_{seg}=9 leading to a rotation phase angle.

$$Φ = π ( 1 - \frac{2}{{N}_{seg}} ) = 7 / 9 π .$$

As can be seen in FIG. 9 the desired middle subcarrier has been cancelled, while the OOK waveform shape is still very good as Φ≈0.78π which is rather close to π. It may be noted that in order to obtain an average power which is symmetrically distributed among the subcarriers, the phase ramp is selected to have random sign, i.e., either +Φ or −Φ, between different transmissions.

With embodiments of the present disclosure, it is possible for a well-chosen set of parameters to produce the Fourier coefficients generating the OFDM signal providing the minimum least square (LS) approximation (also denoted the LS method) of an ideal OOK signal under the given bandwidth allocation constraint. In a conventional solution, the Fourier coefficients providing the LS approximation is a method of high complexity as it needs to introduce a second DFT/FFT of the same size than the OFDM modulation. Even though only K FFT outputs are needed, only a limited complexity reduction could be achieved over a full FFT by using so-called pruned-FFT algorithms. Indeed, the performance gains from pruned-FFTs are in general quite modest of the order of O(N_{fft}log₂K) instead of O(N_{fft}log₂N_{fft}) for K<<N_{fft} outputs at the cost of a significant algorithm optimization effort.

Embodiments of the present disclosure enable generation of the same minimum LS approximation signal but for much less implementation complexity than in the conventional LS solution. If K number of subcarriers is even, N_{fft}/N_{bit} and N_{seg}=N_{symb}/N_{bit} are both integers, Φ=π and

$${T}_{shift} = \frac{{N}_{fft} - 1}{2 {N}_{symb}} - \frac{1}{2} ,$$

the Fourier coefficients of a direct LS approximation with DFT precoder of size N_{fft} and the disclosed embodiments are derived in closed form and shown herein to differ only by amplitude coefficients and a global phase factor, both independent of the bit data. Therefore, with an appropriate FDSS window W₀[k] specified in Eq. (59), the two methods can produce the same Fourier coefficients up to an irrelevant global phase factor. As a direct by-product, if considering the more complex LS method combined with an FDSS window W^{LS}[k], the same Fourier coefficients can also be obtained with the proposed solution of embodiments of the present disclosure but with FDSS window W[k]=W^{LS}[k]W₀[k].

Compared to the Kaiser window discussed previously, it was observed that the expression W₀[k] can be closely approximated by the Kaiser window with the shaping parameter β≈2. Similarly, if the more complex LS method is used with an FDSS Kaiser window with shaping parameters BLS, the disclosed solution of embodiments of the present disclosure would closely approximate it by with the Kaiser window with a larger shaping parameter of about β≲2β^{LS}.

The benefit of the disclosed solution of embodiments of the present disclosure compared to a naïve method for LS approximation is that the same OOK signal may be obtained for much less implementation complexity, since the complexity for both methods is dominated by the size of their respective DFT precoder. This is illustrated in Table 3, below, with two numerical examples where it is seen that the complexity reduction can be of 2 to 3 orders of magnitudes. This is because the FFT size in OFDM modulation are typically large, while WUS signal subcarrier allocation is typically considered to be small. Moreover, here we have assumed that the naïve LS method is implemented with an optimized pruned-FFT algorithms of order N_{fft}log₂K but otherwise this may need even higher complexity: of order N_{fft}log₂N_{fft}. Also, the FFT size considered here is N_{fft}=2048 as in LTE, but the reference FFT size in NR specification is twice higher: N_{fft}=4096 and this would double the complexity of the LS method only.

TABLE 3
Complexity comparison

| | | K = N_{symb} = | K = 24, N_{symb} = |
|---|---|---|---|
| | Complexity order | 72 | 16 |
| Naïve LS method | N_{fft} log₂K | 100% | 100% |
| Disclosed | N_{symb} log₂N_{symb} | 3.5% | 0.68% |
| solution | | | |

The disclosed solution of embodiments of the present disclosure targets good bit error rate (BER) performance for a low power WUR. The BER evaluations confirms that embodiments with a spreading sequence r[m] with a rotation phase angle Φ=π provides the best performance, while the impact of the FDSS window is of less importance. In the case of a receiver with a DC blocker, the embodiment with a corresponding null DC subcarrier is shown to maintain good performance.

The BER is computed as a function of the WUS signal-to-noise ratio (SNR), i.e., the power of the WUS component s^{W}[n] of the transmitted signal s[n] divided by the total noise power. A very simple and low-power receiver for which a 0.15 BER has been argued to be sufficient for WUS. The OFDM transmitter sends a Manchester encoded signal of N_{bit0}=4 using N_{fft}=2048 with a total of 600 modulated subcarrier with 15 kHz subcarrier spacing. The WUS signal is assumed to be of K =72 subcarriers transmitted at the middle of the band, while other subcarriers on both sides are modulated by random BPSK symbols. The signal arrives to the receiver via a multi-tap wireless channel. The time domain line C (TDL-C) channel model with Rayleigh fading as specified in 3GPP, with desired delay spread of 100 ns and 3 km/h velocity.

The received analog signal is first passed through a bandpass filter (BPF) centered around the WUS signal band to remove inter channel interference; then into an envelope detector which consist of a norm operator follow by a low-pass filter to smooth the signal. A 3^{rd} order butterworth filters for the bandpass filter (BPF) and low pass filter (LPF) whose cutoff bandwidth are the WUS bandwidth scaled according to the coefficients, α_{BPF} and α_{LPF}, respectively. Then the signal is passed through ADC, after which the bits are decoded. The ADC is considered to be of low-precision operating at the minimum sampling rate of one sample per OOK state and 2-bit amplitude quantization. The sampling of the ADC is aimed to be at the middle of the OOK state given a reference time that previously obtained via synchronization through the help of a preamble or by blind synchronization e.g., based on the redundancy of the CP. There may be a random synchronization error uniformly distributed in a symmetric sample interval [−Sₑ, Sₑ] with maximum error equal to Sₑ. Assuming a Manchester encoded signal, the detection is performed by direct amplitude comparison of two consecutive samples.

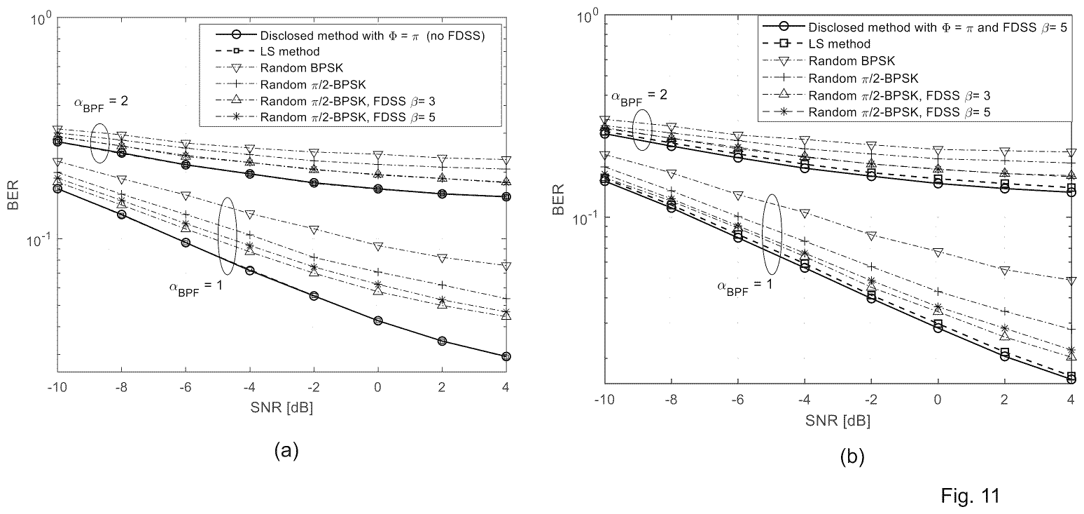

In FIG. 10 we show the BER with a fixed SNR as a function of phase ramp angle Φ and different FDSS coefficients β. Here, assume that bandwidth scaling coefficients of LPF match the WUS bandwidth, i.e., α_{LPF}=1, while considering two values for the BPF: α_{BPF}=2 and 1, for which −2 dB and 0 dB SNR are selected, respectively. Two ranges of synchronization error are chosen,

$${S}_{e} = \frac{{N}_{fft}}{{N}_{bit}} = 128$$

samples which cover the whole segment of an OOK state; and half of the segment Sₑ=64. It may be observed that in general, the BER decreases by increasing Φ until Φ=πThe FDSS shaping β has a slight positive effect for π/2≲Φ≲π when synchronization error is smaller than one OOK state, as FDSS concentrates more energy in the middle range of the states. The FDSS shaping β has always a large negative effect for angle 0≲Φ≲π/2, and also a small negative effect for π/2≲Φ≲π when synchronization error is as large as a OOK state because an FDSS window attenuates the edges of the states.

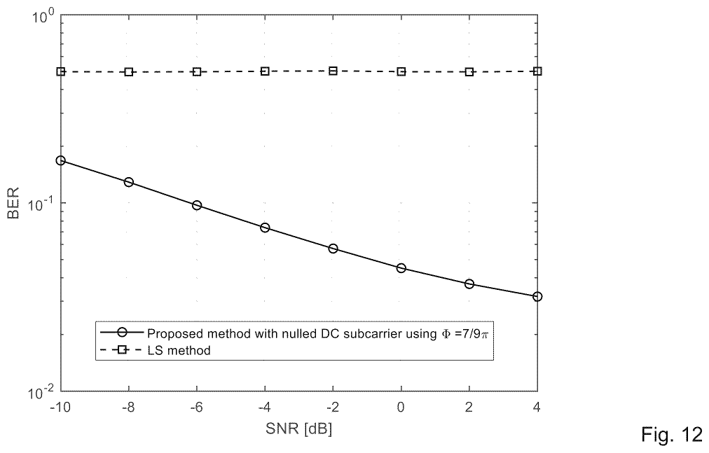

FIG. 11 compares the BER as a function SNR between the disclosed solution of embodiments of the present disclosure and conventional solutions. We select Φ=π with β=0 for Sₑ=128 and β=5 for Sₑ=64. As can be seen in FIG. 11, the proposed solution of embodiments of the present disclosure can slightly outperform the BER over the LS approximation (referred as the LS method in the Fig.) by using more FDSS shaping only when Sₑ=64, i.e., the synchronization error is not too large. This improvement is small, and in general the disclosed solution of embodiments of the present disclosure provides the same BER performance than the LS method by using Φ=π and β=2, as explained above. Nevertheless, recall that the disclosed solution of embodiments of the present disclosure is much less complex than the LS method, while providing further degrees of freedom for optimization.

For further comparison, the disclosed solution of embodiments of the present disclosure is shown to provide larger improvements compared to similar but naïve schemes where bits are spread by mapping them random symbols of BPSK or π/2-BPSK constellation before feeding a DFT-s-OFDM modulation. Note that π/2-BPSK incorporate by construction a linear phase ramp with angle π/2 among consecutive symbols. Using FDSS with π/2-BPSK can improve further its performance, where it was found that the best shaping is β=3. The BER for all curves could be improved by narrowing the bandwidth of the BPF or LPF. Nevertheless, for lower power consumption rather large filter bandwidths may be desired instead.

An embodiment of the present disclosure considers WUR blocks at its analog front the DC component of the received signal. The BER performance evaluation is as before with parameters K=N_{symb}=72, N_{bit0}=4, N_{seg}=9, DC subcarrier at index kₙᵤₗₗ=36, such that according to Eq. (23) to the phase ramp angle is

$$Φ = π ( 1 - \frac{2}{{N}_{seg}} ) = 7 / 9 π .$$

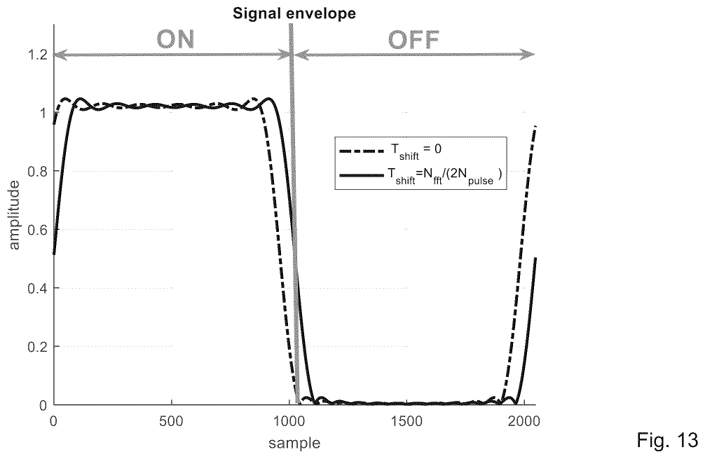

As it can be anticipated from FIG. 12(a) and verified in FIG. 12(b) this change of angle for the phase ramp still provides good performance. This is compared to the LS approximation for which the spectrum cannot be controlled and has most of its energy on the DC subcarrier, which is here filtered out by the receiver.

An FD phase shift that corresponds to cyclic shifting the main lobe of the TD multiplexing pulses by half of their period, i.e.,

$${T}_{shift} \approx \frac{{N}_{fft}}{2 {N}_{symb}}$$

is also considered herein. As explained herein, this is because the first pulse has its energy centered around time zero, and so there is systematic offset in the time-location of the OOK waveforms compared to where they are expected to be. An embodiment of the present disclosure, enabled by the use of CP, includes applying this time delay of T_{shift} samples at the receiver side instead, i.e., the time of reference of the OFDM signal is selected to be −T_{shift} . This offset is more important when the number of pulses is small as then the pulse lobes are large and thus pulses' energy leaks more to neighboring OOK states.

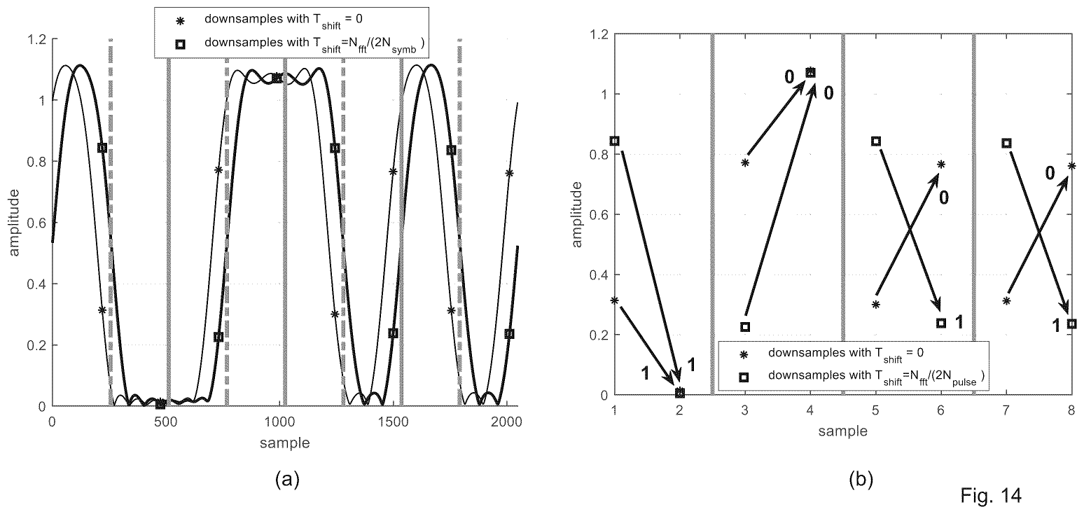

FIG. 13 illustrates the obtained localization correction on a 2-bit OOK signal where the ON and OFF states are expected to span each half of the OFDM symbol duration. The signal is constructed from N_{symb} =16 pulses obtained with K=24 subcarrier of which Nₑ=8 are used for spectral extension. A linear phase ramping with Φ=π is used, and the Fourier coefficients are shaped by an FDSS window with parameter β=4. As can be seen in FIG. 13 the OFF state has its envelope to reach an amplitude close to one.

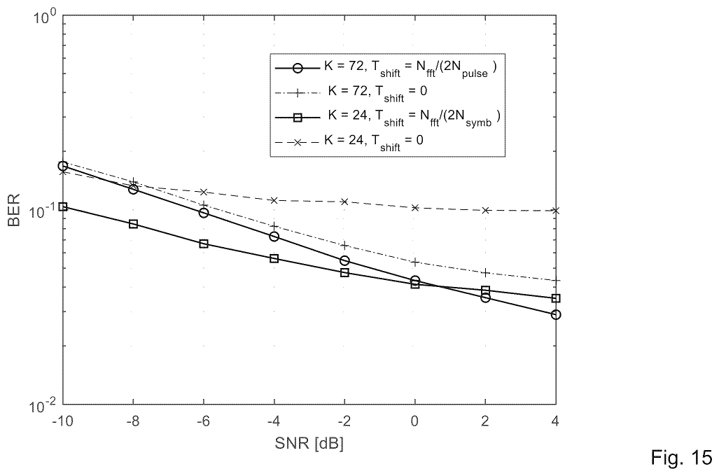

Correcting this time-offset enables more robustness toward synchronization error. FIG. 14 illustrates how this FD phase shift helps in reducing decoding errors in the case of large synchronization error. Here, the signal is dowsampled at the minimum rate of one sample per state, and downsampling starts at the 220^{th} sample instead of the 128^{th} sample in the middle of the waveforms. The considered 8-bit string corresponds to the Manchester encoding of bits [1 0 1 1]. Bits can therefore be decoded by amplitude (or energy) comparison of two consecutive samples as shown in 15(b). As it can be seen the signal that takes into account the time-offset correction of T_{shift} decode correctly the bits to [1 0 1 1], while the signal without time-offset compensation outputs two decoded bit errors with the string [1 0 0 0].

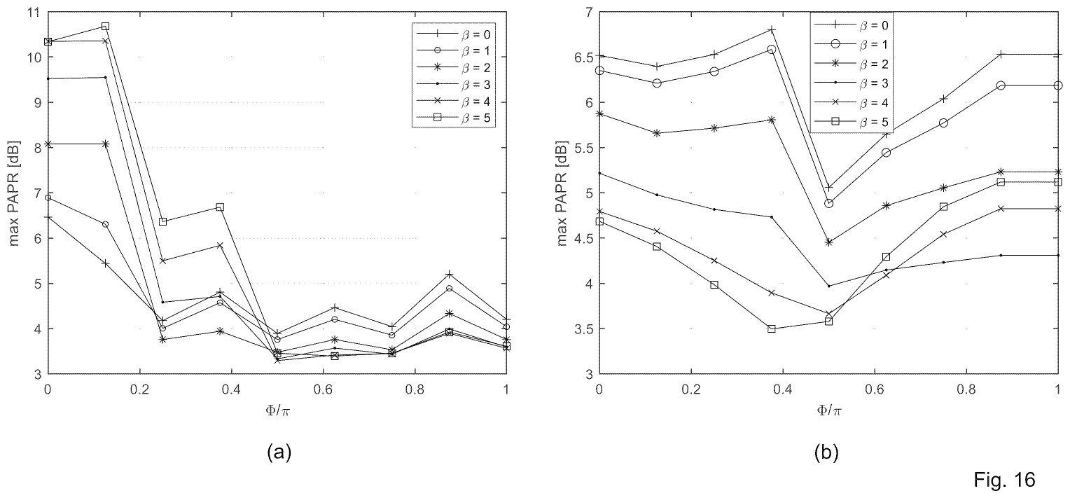

The difference in BER performance with and without FD phase shift is shown on FIG. 15 where similar system assumptions are assumed as previously described. Here, the synchronization error range is selected to cover one full OOK state, i.e., Sₑ=128, and OOK waveforms are generated using Φ=π and β=2. Two cases of bandwidth allocation are considered, i.e., K=24 and K=72, where it can be verified that the performance gap is larger with the small bandwidth allocation since the pulse lobes are larger in this case and have more energy leakage to other OOK state without proper TD shifting as achieved by the proposed FD phase rotation.

In an embodiment of the present disclosure and as an alternative to the FD phase shifting includes using guard symbols, where some symbols at the input of the DFT precoder are systematically set to zero. Guard symbols could also be used between different states to avoid energy leakages between the ON and OFF states. However, using guard symbols is in general suboptimal as it decreases the width of the ON state, rendering the signal more sensitive to synchronization errors. It should be noted that guard symbols are different than guard subcarriers at the input of OFDM modulation. Guard subcarriers could be also beneficial for the disclosed solution of embodiments of the present disclosure in order to decrease interference from concurrent data transmission.

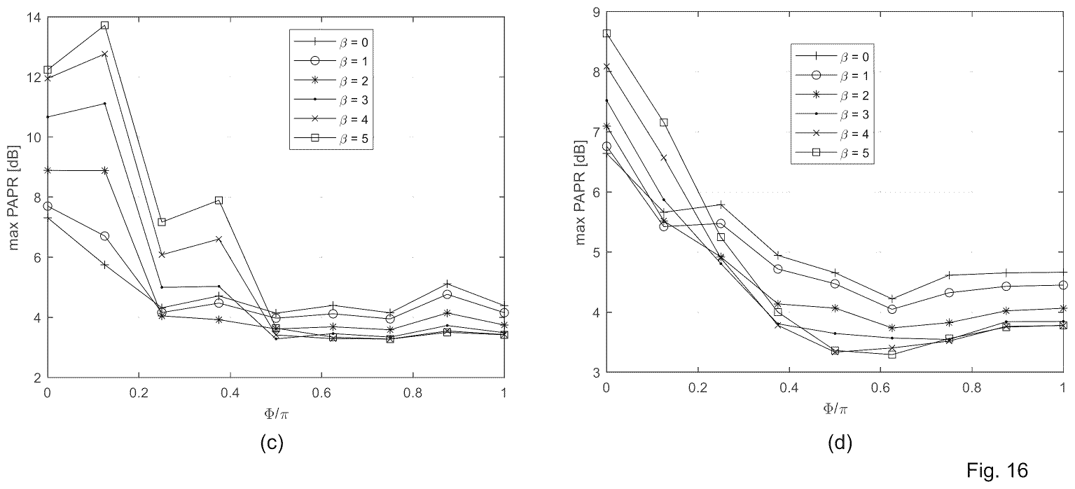

The PAPR performance of the proposed solution of embodiments of the present disclosure is also considered for a standalone WUS transmission, i.e., where there are no other concurrent data transmitted along. The maximum PAPR as a function of the rotational phase angle Φ is shown on FIG. 16 for four different combinations of K and N_{bit0}. In the cases of N_{bit0}=8, spectrum extension with Nₑ=8 is used. Good PAPR of around 4 dB can be obtained primarily in the range π/2≲Φ≲π, which coincides with the angles providing good BER performance. In this angle range for all cases in FIG. 16 except the case (b), increasing the FDSS shaping β improves the PAPR. In FIG. 16(b), for π/2≤ ≤π, increasing the FDDS shaping β improves the PAPR up to β=3. Moreover, we see in this case (b) that there is a clear optimum at Φ=π/2 for each curve with a fixed β. Further numerical evaluations show that Φ=π/2 provides the best PAPR when N_{seg}=1, i.e., when there is no bit spreading and only one pulse per bit. When the bit spreading is increased, the PAPR variations in the range π/2≤Φ≤π n are flattening. When the bit spreading is not so large, as in case (d) with N_{seg}=4, one sees that optimum PAPRs for a given β are in an angle in between π/2 and π. The angle Φ=3π/4 may therefore provide a good tradeoff to cover several scenarios.

It can be remarked that the special case of Fourier coefficients in Eq. (58) could be implemented as a DFT precoding of the bits without explicit spreading as

$${X}^{W} [ k ] = α {e}^{- \frac{j 2 π}{{N}_{fft}} {T}_{shift}^{K}} {W}^{″ [ k ]} {D}^{( se )} [ k ] \qquad ( 26 )$$

where only the N_{bit} are DFT-precoded as

$$D [ k ] = {\sum }_{m = 0}^{{N}_{b i t} - 1} b [ m ] {e}^{- j \frac{2 π m}{{N}_{b i t}} k} , for k = 0 , … , {N}_{b i t} - 1 , \qquad ( 27 )$$

then repeated by symmetric spectrum extension as

$$\begin{matrix}{D}^{( se )} [ k ] = D [ k - \frac{K}{2} ( mod {N}_{b i t} ) , ] k = 0 , … , K - 1 \\ = {\sum }_{m = 0}^{{N}_{b i t} - 1} b [ m ] {e}^{j \frac{2 π m}{{N}_{b i t}} ( \frac{K}{2} - k )} .\end{matrix} \qquad ( 28 )$$

Then to which FDSS is applied as

$${X}^{′} [ k ] = {W}^{″} [ k ] {D}^{( s e )} [ k ] \qquad ( 29 )$$

where the FDSS window is

$${W}^{″ [ k ]} = \{ \begin{matrix}W [ k ] \frac{sin ( \frac{π}{{N}_{bit}} ( \frac{K}{2} - k ) )}{sin ( \frac{π}{{N}_{symb}} ( \frac{K}{2} - k ) )} & k \neq \frac{K}{2} ; k = 0 , … , K - 1 \\ {N}_{symb} / {N}_{bit} & k = K / 2\end{matrix} \qquad ( 30 )$$

The FD shift with

$${T}_{shift} = \frac{{N}_{fft}}{2} ( \frac{1}{{N}_{bit}} - \frac{1}{{N}_{fft}} )$$

as previously described may be used.

As aforementioned, the transmit device 100 herein disclosed may be any type of suitable communication device. Nonlimiting examples are network access nodes and client devices.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the present disclosure may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the transmit device 100 comprises the necessary communication capabilities in the form of e.g., functions, means, units, elements, etc., for performing or implementing embodiments of the present disclosure. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the transmit device 1000 may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like. Finally, it should be understood that the invention is not limited to the embodiments described above, but also relates to and incorporates all embodiments within the scope of the appended independent claims.

### Appendix A

Without loss of generality, assume that the starting WUS subcarrier is K₀=0. After inserting Eq. (9)-(15) in Eq. (6) and assuming that T_{shift} is an integer, the WUS becomes equivalent to

$${s}^{W} [ n ] = {\sum }_{m = 0}^{{N}_{symb} - 1} d [ m ] {g}_{m} [ n ] , \qquad ( 31 )$$

i.e., it is the multiplexing of the symbols d[m] by N_{symb} pulses given by

$${g}_{m} [ n ] = {e}^{- j \frac{2 π L}{{N}_{s y m b}} m} h [ n - {T}_{shift} - \frac{{N}_{fft}}{{N}_{symb}} m ] \qquad ( 32 )$$

which are all a different time-shifted versions of the same pulse shaping filter

$$h [ n ] = {\sum }_{k = 0}^{K - 1} W [ k ] {e}^{j \frac{2 π k}{{N}_{fft}} n} . \qquad ( 33 )$$

This filter is the inverse discrete Fourier transform of the FDSS window. In the case of no FDSS windowing, W[0]= . . . =W[N_{sc}−1]=1, this further reduces to the DFT-s-OFDM pulses, in the form of a Dirichlet kernel, with N_{sc} modulated subcarriers:

$$h [ n ] = {e}^{j \frac{π}{{N}_{fft}} n ( K - 1 )} \frac{sin ( π \frac{K}{{N}_{fft}} n )}{sin ( π \frac{1}{{N}_{fft}} n )} . \qquad ( 34 )$$

With a typical windowing function W[k], the pulses |gₘ[n]| remain essentially of sinc-shape but with more or less attenuated side lobes.

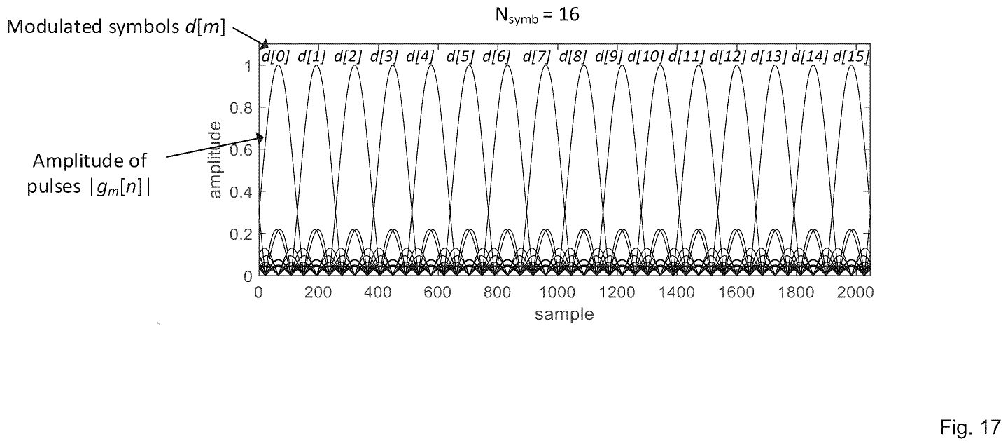

An illustration of the resulting TD pulse multiplexing effect of DFT precoding over OFDM is shown in FIG. 17. Here, K=24 subcarriers are considered but there are only N_{symb}=16 pulses as a SE of size Nₑ=8 is used. The pulses have been shifted by

$${T}_{shift} = round ( \frac{{N}_{fft}}{2 {N}_{symb}} )$$

samples. No FDDS is used here.

Now by inserting Eq. (19) in Eq. (31), the signal is equivalent to

$$\begin{matrix}{s}^{W} [ n ] = {\sum }_{m = 0}^{{N}_{pulse} - 1} b [ ⌊ m / {N}_{seg} ⌋ ] {e}^{j ( {ϕ}_{m} - \frac{2 π L}{{N}_{symb}} m )} h [ n - {T}_{shift} - \frac{{N}_{fft}}{{N}_{symb}} m ] \\ = {\sum }_{p = 0}^{{N}_{b i t} - 1} b [ p ] ( {\sum }_{m = {pN}_{seg}}^{( p + 1 ) {N}_{seg} - 1} {e}^{j ( {ϕ}_{m} - \frac{2 π L}{{N}_{symb}} m )} h [ n - {T}_{shift} - \frac{{N}_{fft}}{{N}_{symb}} m ] ) \\ = {\sum }_{p = 0}^{{N}_{bit} - 1} b [ p ] {O}_{p} [ n ]\end{matrix} \qquad ( 35 )$$

$$where$$

$${O}_{p} [ n ] = ( {\sum }_{m = {pN}_{seg}}^{( p + 1 ) {N}_{seg} - 1} {e}^{j {ϕ}_{m}} {g}_{m} [ n ] ) \qquad ( 36 )$$

is the OOK waveform for the bit b[p].

Each pulse gₘ[n] has most of its energy during sample interval

$$[ \frac{{N}_{fft}}{{N}_{symb}} m , \frac{{N}_{fft}}{{N}_{symb}} ( m + 1 ) ]$$

time-multiplexing of the bits where each bit b[p] is transmitted by the waveform Oₚ[n] where most of the potential combined energy is in the sample interval

$$Support of {O}_{p} [ n ] = \{ \frac{{N}_{fft} {N}_{seg}}{{N}_{symb}} p , … , \frac{{N}_{fft} {N}_{seg}}{{N}_{symb}} ( p + 1 ) \} \qquad ( 37 )$$

which with N_{symb}=N_{bit}N_{seg} simplifies to

$$Support of {O}_{p} [ n ] = \{ \frac{{N}_{fft}}{{N}_{bit}} p , … , \frac{{N}_{fft}}{{N}_{bit}} ( p + 1 ) \} . \qquad ( 38 )$$

Based on this structure, the main design target becomes to find relevant pulse phase rotations that notably guarantee a coherent combining of the pulses in the same segment.

The phase difference between two neighboring pulses of indices m and (m+1) is

$$∠ \frac{{g}_{m + 1} [ n ]}{{g}_{m} [ n ]} = - \frac{2 π L}{{N}_{symb}} + ∠ \frac{h [ n - \frac{{N}_{fft}}{{N}_{symb}} ( m + 1 ) ]}{h [ n - \frac{{N}_{fft}}{{N}_{symb}} m ]} . \qquad ( 39 )$$

Then, if the FDSS window is real and symmetric it provides

$$∠ \frac{h [ n - \frac{{N}_{fft}}{{N}_{symb}} ( m + 1 ) ]}{h [ n - \frac{{N}_{fft}}{{N}_{symb}} m ]} = - \frac{( K - 1 )}{{N}_{symb}} π + θ [ n ] \qquad ( 40 )$$

The function θ[n]={0 or π} corresponds to a sign difference between the real part of the pulses, and changes as a function of n. Nevertheless, it can be verified that in the case of no FDSS and no spectral extension this constant is equal to θ[n]=0 for all samples between two neighboring pulses. So, assuming θ[n]=0, L=0 and Nₑ=0,

$$∠ \frac{{g}_{m + 1} [ n ]}{{g}_{m} [ n ]} = - \frac{π ( {N}_{symb} - 1 )}{{N}_{symb}} . \qquad ( 41 )$$

Therefore

$$∠ \frac{{e}^{j {ϕ}_{m + 1}} {g}_{m + 1} [ n ]}{{e}^{j {ϕ}_{m}} {g}_{m} [ n ]} = {ϕ}_{m + 1} - {ϕ}_{m} - \frac{π ( {N}_{symb} - 1 )}{{N}_{symb}} . \qquad ( 42 )$$

So, by selecting

$$Φ = {ϕ}_{m + 1} - {ϕ}_{m} = \frac{π ( {N}_{symb} - 1 )}{{N}_{symb}} , \qquad ( 43 )$$

one gets

$$∠ \frac{{e}^{j ϕ m + 1} {g}_{m + 1} [ n ]}{{e}^{j ϕ m} {g}_{m} [ n ]} = 0 .$$

AS the number of pulses is in practice never small, this is well approximated by selecting Φ=π.

In the case of SE, it can be verified also that θ[n]=0 for the samples where the main lobes of the neighboring pulse are crossing. So, assume again that θ[n]=0, and

$$∠ \frac{{g}_{m + 1} [ n ]}{{g}_{m} [ n ]} = - \frac{2 π L}{{N}_{symb}} - \frac{( K - 1 )}{{N}_{symb}} π = - \frac{π}{{N}_{symb}} ( 2 L + K - 1 ) \qquad ( 44 )$$

$$Φ = {ϕ}_{m + 1} - {ϕ}_{m} = \frac{π ( 2 L + K - 1 )}{{N}_{symb}} \qquad ( 45 )$$

which in practice is also typically well approximated by the value π.

### Appendix B

Recall that the modulation symbols are selected to be d[m] =bᵣ[m]e^{jΦm}, where bᵣ is a sequence made of segment of Is and segment of 0s where each segment of 1s have length N_{seg}. Assume there are Nₒₙₑₛ segment of ones and let the segment of ones starting at indices m_{b}_{₁}, m_{b}_{₂}, . . .

$${m}_{{b}_{{N}_{ones}}} .$$

Consider the output of DFT precoding Eq. (10) with index k∈{0, . . . , N_{symb}−1}, it is given by

$$\begin{matrix}D [ k ] = {\sum }_{m = 0}^{{N}_{symb} - 1} d [ m ] {e}^{- \frac{j 2 π mk}{{N}_{symb}}} \\ = {\sum }_{m = 0}^{{N}_{pulse} - 1} {b}_{s} [ m ] {e}^{jm ( Φ - \frac{2 π k}{{N}_{symb}} )} \\ = {\sum }_{i = 0}^{{N}_{ones} - 1} {\sum }_{m = 0}^{{N}_{seg} - 1} {\underbrace{{b}_{s} [ {m}_{{b}_{i}} + m ]}}_{= 1} {e}^{j ( {m}_{{b}_{i}} + m ) ( Φ - \frac{2 π k}{{N}_{symb}} )} \\ = {\sum }_{i = 0}^{{N}_{ones} - 1} {e}^{{jm}_{{b}_{i}} ( Φ - \frac{2 π k}{{N}_{symb}} )} {\sum }_{m = 0}^{{N}_{seg} - 1} {e}^{jm ( Φ - \frac{2 π k}{{N}_{symb}} )} .\end{matrix} \qquad ( 46 )$$

Therefore, if N_{seg}>1 and

$$Φ = 2 π ( \frac{{k}_{null}}{{N}_{symb}} + \frac{λ}{{N}_{seg}} )$$

where λ is any non-zero integer then

$$( Φ - \frac{2 π {k}_{null}}{{N}_{symb}} ) = - \frac{2 π}{{N}_{seg}} λ ,$$

and the inner sum is zero, i.e., the Fourier coefficient is D[kₙᵤₗₗ]=0.

Without SE D[kₙᵤₗₗ] is directly mapped to subcarrier index kₙᵤₗₗ∈{0, . . . , K−1}. Otherwise in the case of SE with shift L, the Fourier coefficient D[kₙᵤₗₗ] is mapped to coefficient

$${D}^{( s e )} [ {k}_{null}^{′} ]$$

indexed with

$${k}_{null}^{′} = L + {k}_{null} ( mod {N}_{pulse} )$$

where

$${k}_{null}^{′} ∈ \{ 0 , … , K - 1 \} .$$

Assuming that the DC subcarrier is at index

$${k}_{null}^{′} = ⌊ \frac{{N}_{s c}}{2} ⌋ ,$$

one then needs to null the DFT coefficient D[Kₙᵤₗₗ] at index

$$l = ⌊ \frac{K}{2} ⌋ - L .$$

### Appendix C

The Fourier coefficients generating the LS approximation as previously discussed are obtained from the N_{fft}-point FFT as

$${D}^{LS} [ n ] = {\sum }_{k = 0}^{{N}_{fft} - 1} {b}_{r}^{LS} [ k ] {e}^{- j \frac{2 π}{{N}_{fft}} nk} \qquad ( 47 )$$

where the ideal target OOK signal

$${b}_{r}^{LS} [ k ]$$

of length N_{fft} is obtained by repeating each bit

$$( {N}_{seg}^{LS} = \frac{{N}_{fft}}{{N}_{bit}} ) - times$$

in the string b[m] of length N_{bit}. Therefore,

$${b}_{r}^{LS}$$

segment of

$${N}_{seg}^{LS}$$

samples such that

$$\begin{matrix}{D}^{LS} [ n ] = {\sum }_{m = 0}^{{N}_{bit} - 1} b [ m ] {\sum }_{k = {mN}_{seg}^{LS}}^{( m + 1 ) {N}_{seg}^{LS} - 1} {e}^{- j \frac{2 π}{{N}_{fft}} nk} \\ = {\sum }_{m = 0}^{{N}_{bit} - 1} b [ m ] {e}^{j \frac{2 π}{{N}_{fft}} {nmN}_{seg}^{LS}} {\sum }_{k = 0}^{{N}_{seg}^{LS} - 1} {e}^{- j \frac{2 π}{{N}_{fft}} nk} .\end{matrix} \qquad ( 48 )$$

If n=0,

$${D}^{LS} [ 0 ] = \frac{{N}_{fft}}{{N}_{bit}} {\sum }_{m = 0}^{{N}_{bit} - 1} b [ m ] ,$$

otherwise if n≠0, use the exponential sum formula to get

$$\begin{matrix}{D}^{LS} [ n ] = {\sum }_{m = 0}^{{N}_{bit} - 1} b [ m ] {e}^{- j \frac{2 π}{{N}_{fft}} {nmN}_{seg}^{LS}} \frac{sin ( - π \frac{{N}_{seg}^{LS}}{{N}_{fft}} n )}{sin ( - π \frac{n}{{N}_{fft}} )} {e}^{- j \frac{π}{{N}_{fft}} n ( {N}_{seg}^{LS} - 1 )} . \\ = {e}^{- j π n ( \frac{1}{{N}_{bit}} - \frac{1}{{N}_{fft}} )} \frac{sin ( π \frac{n}{{N}_{bit}} )}{sin ( π \frac{n}{{N}_{fft}} )} ( {\sum }_{m = 0}^{{N}_{bit} - 1} b [ m ] {e}^{- j 2 π \frac{nm}{{N}_{bit}}} )\end{matrix} \qquad ( 49 )$$

Finally, if K is even, the Fourier coefficients for WUS with index k=0, . . . , K−1 are

$${X}^{W , LS} [ k ] = {D}^{LS} [ k - \frac{K}{2} ( mod {N}_{fft} ) ] \qquad ( 50 )$$

For the middle subcarrier, one gets

$${X}^{W , LS} [ K / 2 ] = \frac{{N}_{fft}}{{N}_{bit}} {\sum }_{m = 0}^{{N}_{bit} - 1} b [ m ] \qquad ( 51 )$$

otherwise for other indices k≠K/2, we get the closed-form expression

$$( 52 )$$

$${X}^{W , LS} [ k ] = {α}^{LS} {e}^{- j π k ( \frac{1}{{N}_{bit}} - \frac{1}{{N}_{fft}} )} \frac{sin ( \frac{π}{{N}_{bit}} ( \frac{K}{2} - k ) )}{sin ( \frac{π}{{N}_{fft}} ( \frac{K}{2} - k ) )} ( {\sum }_{m = 0}^{{N}_{bit} - 1} b [ m ] {e}^{j \frac{2 π m}{{N}_{bit}} ( \frac{K}{2} - k )} )$$

where

$${α}^{LS} = {e}^{j π \frac{K}{2} ( \frac{1}{{N}_{bit}} - \frac{1}{{N}_{fft}} )}$$

is an irrelevant global phase.

For the herein disclosed solution of embodiments of the present disclosure, the bits are spread by factor N_{seg}=N_{symb}/N_{bit} and pulse phase ramp with angle Φ, such that we have for k=0, . . . , N_{symb}−1

$$\begin{matrix}D [ k ] = {\sum }_{m = 0}^{{N}_{symb} - 1} d [ m ] {e}^{- \frac{j 2 π mk}{{N}_{symb}}} \\ = {\sum }_{m = 0}^{{N}_{bit} - 1} b [ m ] {e}^{{jmN}_{seg} ( Φ - \frac{2 π k}{{N}_{symb}} )} {\sum }_{l = 0}^{{N}_{seg} - 1} {e}^{jl ( Φ - \frac{2 π k}{{N}_{symb}} )} .\end{matrix} \qquad ( 53 )$$

### If

$$k = \frac{{N}_{symb} Φ}{2 π}$$

then

$$( Φ - \frac{2 π k}{{N}_{symb}} ) = 0 ,$$

$$and$$

$$D [ \frac{{N}_{symb} Φ}{2 π} ] = \frac{{N}_{symb}}{{N}_{bit}} {\sum }_{m = 0}^{{N}_{bit} - 1} b [ m ] .$$

Otherwise, any index k such that

$$( Φ - \frac{2 π k}{{N}_{symb}} ) \neq 0 ,$$

to get

$$D [ k ] = {e}^{j ( {N}_{s e g} - 1 ) ( Φ / 2 \frac{π k}{{N}_{s y m b}} )} \frac{sin ( {N}_{s e g} Φ / 2 - \frac{π k}{{N}_{b i t}} )}{sin ( Φ / 2 - \frac{π k}{{N}_{s y m b}} )} ( {\sum }_{m = 0}^{{N}_{b i t} - 1} b [ m ] {e}^{j m {N}_{s e g} ( Φ - \frac{2 π k}{{N}_{s y m b}} )} ) . \qquad ( 54 )$$

Now by selecting the pulse phase ramp angle as Φ=π, this simplifies to

$$D [ k ] = {e}^{j π ( \frac{1}{{N}_{b i t}} - \frac{1}{{N}_{s y m b}} ) ( \frac{{N}_{s y m b}}{2} - k )} \frac{sin ( \frac{π}{{N}_{b i t}} ( \frac{{N}_{s y m b}}{2} - k ) )}{sin ( \frac{π}{{N}_{s y m b}} ( \frac{{N}_{s y m b}}{2} - k ) )} ( {\sum }_{m = 0}^{{N}_{b i t} - 1} b [ m ] {e}^{j \frac{2 π m}{{N}_{b i t}} ( \frac{{N}_{s y m b}}{2} - k )} \qquad ( 55 )$$

If the Fourier coefficient are spectrally extended with the shift

$$L = - \frac{K - {N}_{s y m b}}{2}$$

for indices k=0, . . . , K−1,

$${D}^{( se )} [ k ] = D [ k − \frac{( K − {N}_{symb} )}{\text{?}} ( \text{} mod \text{} N \text{?} ) ] = {e}^{j π ( \frac{1}{{N}_{b i t}} - \frac{1}{{N}_{s y m b}} ) ( \frac{K}{2} - k )} \frac{sin ( \frac{π}{{N}_{b i t}} ( \frac{K}{2} - k ) )}{sin ( \frac{π}{{N}_{s y m b}} ( \frac{K}{2} - k ) )} ( {\sum }_{m = 0}^{{N}_{b i t} - 1} b [ m ] {e}^{j \frac{2 π m}{{N}_{b i t}} ( \frac{K}{2} - k )} ) . \qquad ( 56 )$$

$$\text{?} \text{indicates text missing or illegible when filed}$$

Finally, by applying an FDSS window W[k] and FD shift, the Fourier coefficients of WUS are obtained as

$${X}^{W} [ k ] = {e}^{- \frac{j 2 π}{{N}_{fft}} {T}_{{shift}^{K}}} W [ k ] {D}^{( s e )} [ k ] , for k = 0 , … , K - 1. \qquad ( 57 )$$

With shift value

$${T}_{shift} = \frac{{N}_{fft} - 1}{2 {N}_{s y m b}} - \frac{1}{2} ,$$

this sums up as

$${X}^{W} [ k ] = {ae}^{- j π k ( \frac{1}{{N}_{b i t}} - \frac{1}{{N}_{fft}} )} W [ k ] \frac{sin ( \frac{π}{{N}_{b i t}} ( \frac{K}{2} - k ) )}{sin ( \frac{π}{{N}_{s y m b}} ( \frac{K}{2} - k ) )} ( {\sum }_{m = 0}^{{N}_{b i t} - 1} b [ m ] {e}^{j \frac{2 π m}{{N}_{b i t}} ( \frac{K}{2} - k )} ) . \qquad ( 58 )$$

Now comparing Eq. (52) and (58), the Fourier coefficient only differs by amplitude coefficients and a global phase, both independent of the data bits. Explicitly, defining in the disclosed solution the FDSS window to be

$${W}_{0} [ k ] = \{ \begin{matrix}\frac{sin ( \frac{π}{{N}_{symb}} ( \frac{K}{2} − k ) )}{sin ( \frac{π}{{N}_{fft}} ( \frac{K}{2} − k ) )} & k \neq \frac{K}{2} ; k = 0 , … , K − 1 \\ {N}_{fft} / {N}_{symb} & k = K / 2\end{matrix} . \qquad ( 59 )$$

one gets

$${X}^{W} [ k ] = \frac{α}{{α}^{L S}} {X}^{W , L S} [ k ] , where \frac{α}{{α}^{L S}}$$

is a global phase factor independent of k. Thus, the disclosed solution of embodiments of the present disclosure and the conventional LS method provide the same Fourier coefficients up to the global phase.

### Appendix D

In the case the spreading factor N_{seg} is not directly an integer given the subcarrier allocation K we show that using SE provides a better performance than using two spreading factors for ON and OFF states when it is possible. The evaluation scenario is with the values Φ=π, β=2, and α_{BPF}=1. Here, K=72 and

$${N}_{bit 0} = 8 so \frac{K}{{N}_{b i t}}$$

is not an integer but

$$\frac{K}{{N}_{bit 0}} = 9.$$

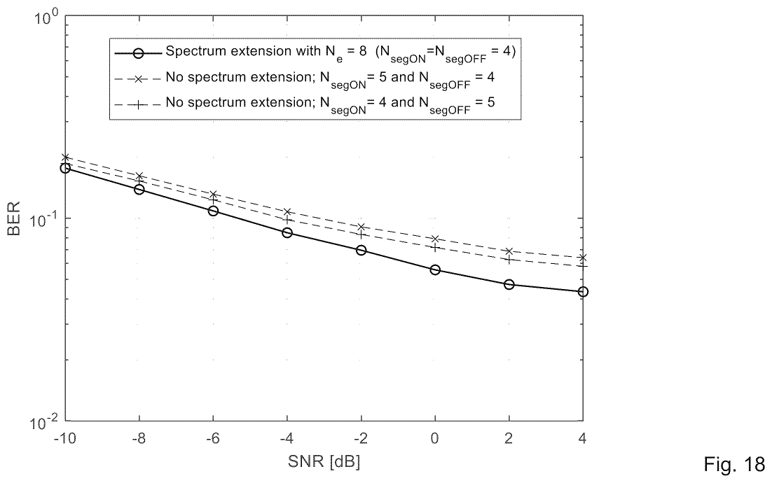

By using a spectrum extension of Nₑ=8 one can get an integer spreading factor of N_{seg}=4, that has the same spreading factor N_{segON}=N_{segOFF}=4 per OOK state. In an embodiment of the present disclosure, one can use (N_{segON}=5, N_{segOFF}=4), or (N_{segON}=4, N_{segOFF}=5). As shown in FIG. 18, having a constant spreading factor per bit thanks to SE provides a better performance than the alternative with different spreading factors for ON and OFF states.

1. An apparatus, comprising:
one or more processors in communications with a non-transitory memory storing computer instructions, wherein the computer instructions, when executed by the one or more processors, cause the apparatus to:
spread a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle Φ;
multiply the N_{symb} number of modulation symbols with a discrete Fourier transform precoder to obtain N_{symb} number of Fourier coefficients; and
transmit an orthogonal frequency-division multiplexing (OFDM) signal comprising the N_{symb} number of Fourier coefficients mapped onto K number of OFDM subcarriers.

2. The apparatus according to claim 1, wherein spreading the N_{bit} number of bits is based on:
repeat the N_{bit} number of bits to obtain a sequence of N_{symb} number of repeated bits; and
multiply the N_{symb} number of repeated bits with a concatenated spreading sequence to obtain the N_{symb} number of modulation symbols, wherein the concatenated spreading sequence is a concatenation of the N_{bit} number of spreading sequences so that the concatenated spreading sequence is the linear phase sequence with the constant rotational phase angle Φ.

3. The apparatus according to claim 1, wherein the N_{bit} number of bits are Manchester encoded bits based on a sequence of N_{bit}/2 number of bits.

4. The apparatus according to claim 1, wherein the a spreading sequence rₗ[m] of the spreading sequences is given by the formula:
$${r}_{l} [ m ] = {e}^{j Φ m + {Φ}_{l}}$$
where l is a bit index, m is a modulation symbol index, e is the natural exponential function, j is the imaginary unit, and Φₗ is a constant angle that depends on the bit index l.

5. The apparatus according to claim 4, wherein the constant rotational phase angle Φ is equal to π.

6. The apparatus according to claim 4, wherein the spreading sequence rₗ[m] is an alternating sequence of the values +1 and −1.

7. The apparatus according to claim 4, wherein the spreading sequence rₗ[m] is an alternating sequence of two binary shift keying symbols.

8. The apparatus according to claim 4, wherein the constant rotational phase angle Φ is given by the formula:
$$Φ = 2 π ( \frac{{k}_{null}}{{N}_{s y m b}} + \frac{λ}{{N}_{s e g}} )$$
where N_{seg} is the length of the spreading sequence rₗ[m], kₙᵤₗₗ is an index for a nulled Fourier coefficient, and λ is any non-zero integer.

9. The apparatus according to claim 1, wherein the discrete Fourier transform precoder has size N_{symb}≤K.

10. The apparatus according to claim 1, wherein the computer instructions, when executed by the one or more processors. cause the apparatus to:
extend the N_{symb} number of Fourier coefficients into K number of Fourier coefficients based on a periodic repetition of the N_{symb} number of Fourier coefficients.

11. The apparatus according to claim 10, wherein the instructions, when executed by the one or more processors, cause the apparatus to:
multiply the N_{symb} number of Fourier coefficients or the K number Fourier coefficients with frequency-domain spectral shaping window coefficients to obtain frequency-shaped Fourier coefficients.

12. The apparatus according to claim 11, wherein the frequency-domain spectral shaping window coefficients are real valued symmetric coefficients from a bell-shaped function.

13. The apparatus according to claim 12, wherein the frequency-domain spectral shaping window coefficients are Kaiser window coefficients with the shaping parameter β=2.

14. The apparatus according to claim 11, wherein the frequency-domain spectral shaping window coefficients W₀[k] are given by the formula:
$${W}_{0} [ k ] = \{ \begin{matrix}\frac{sin ( \frac{π}{{N}_{symb}} ( \frac{K}{2} − k ) )}{sin ( \frac{π}{{N}_{fft}} ( \frac{K}{2} − k ) )} & k \neq \frac{K}{2} ; k = 0 , … , K − 1 \\ {N}_{fft} / {N}_{symb} & k = K / 2\end{matrix}$$
where N_{fft} is a number of samples of the OFDM signal, and sin( ) is the sinus function.

15. The apparatus according to claim 11, wherein the instructions, when executed by the one or more processors, cause the apparatus to:
multiply the frequency-shaped Fourier coefficients with a frequency-domain phase shift to obtain phase shifted Fourier coefficients, wherein the frequency-domain phase shift is based on a shifting parameter T_{shift}.

16. The apparatus according to claim 15, wherein a value of the shifting parameter T_{shift} is dependent on a number of samples of the OFDM signal N_{fft} and the N_{symb} number of modulation symbols.

17. The apparatus according to claim 16, wherein the value of the shifting parameter T_{shift} is given by any one of the formulas:
$${T}_{shift} = \frac{{N}_{fft}}{2 {N}_{s y m b}}$$
$${T}_{shift} = \frac{{N}_{fft}}{2 {N}_{s y m b}} - \frac{1}{2}$$
$${T}_{shift} = ⌈ \frac{{N}_{fft}}{2 {N}_{s y m b}} ⌉$$
$${T}_{shift} = ⌊ \frac{{N}_{fft}}{2 {N}_{s y m b}} ⌋$$
$${T}_{shift} = round [ \frac{{N}_{fft}}{2 {N}_{s y m b}} ]$$
where N_{fft} is the number of samples of the OFDM signal, ┌ ┐ is a ceiling function, └ ┘ is a floor function, and round[ ] is a rounding function.

18. The apparatus according to claim 1, wherein the OFDM signal is a wake-up signal.

19. A method implemented by a processor, the method comprising:
spreading a sequence of N_{bit} number of bits to obtain N_{symb} number of modulation symbols based on multiplying each bit in the sequence of N_{bit} number of bits with a corresponding spreading sequence in a sequence of N_{bit} number of spreading sequences, wherein each spreading sequence in the sequence of N_{bit} number of spreading sequences is a linear phase sequence having a constant rotational phase angle Φ;
multiplying the N_{symb} number of modulation symbols with a discrete Fourier transform precoder to obtain N_{symb} number of Fourier coefficients; and
transmitting an orthogonal frequency-division multiplexing (OFDM) signal comprising the N_{symb} number of Fourier coefficients mapped onto K number of OFDM subcarriers.

20. The method according to claim 19, wherein spreading the N_{bit} number of bits is based on:
repeat the N_{bit} number of bits to obtain a sequence of N_{symb} number of repeated bits; and
multiply the N_{symb} number of repeated bits with a concatenated spreading sequence to obtain the N_{symb} number of modulation symbols, wherein the concatenated spreading sequence is a concatenation of the N_{bit} number of spreading sequences so that the concatenated spreading sequence is a the linear phase sequence with the constant rotational phase angle Φ.
